(19) United States
(12) Patent Application Publication
(10) Pub. No.: US 2004/0098342 A1
(43) Pub. Date: May 20, 2004

(54) Information processing device and information displaying method

(76) Inventors: Toshiaki Onishi, Yokohama-shi (JP); Akira Ichikawa, Saitama (JP); Akira Ichikawa, Sakura-shi (JP); Ikuo Amino, Hirataka-shi (JP); Masahiko Isshiki, Shinagawa-ku (JP); Hidekazu Tanigawa, Hirakata-shi (JP)

Correspondence Address: PITNEY, HARDIN, KIPP & SZUCH LLP, 685 THIRD AVENUE, NEW YORK, NY, 10017-4024, US

(21) Appl. No.: 10/398,090

(22) PCT Filed: Apr. 23, 2001
(86) PCT No.: PCT/JP01/03465

(30) Foreign Application Priority Data
Nov. 30, 2000 (JP) 2000-366008

(51) Int. Cl. H04K 1/00; H04L 9/00; G06F 17/60

(52) U.S. Cl. 705/51

(57) ABSTRACT

Electronic device products and the like are components, which constitute finished or planned and developed products in the future. Therefore, in addition to obtaining information for each component, to retrieve information from finished products is desirable.

The apparatus allows one to visualize a data for a device component, determine whether there is information regarding a party providing a component at first sight. Further, it is also an object to control timeliness of disclosure of information and range of disclosure of information by a group identifier and the like, which are assigned to an access person, in regard to important information like information related to a component and the like.

### BACKGROUND OF INVENTION

1. Field of the Invention

This invention relates to an information processing apparatus, more specifically, one which displays information regarding components of a device and an information display process.

2. Description of the Related Art

A computer, via a communications network and in an information security system, generally provides information regarding products. More specifically, advancement of the Internet makes it possible to install the WWW (World Wide Web) server, show information regarding products and collect information related to the needs of customers. Such an information-provision system of products and the like is generally designed to retrieve information regarding products from a category assigned to each product and obtain only information regarding one product as a result. Obtaining information regarding each component is required for obtaining information regarding all components, which compose a finished product.

On the other hand, products such as electronic devices and electronic modules, the customers of which are typically limited to companies are produced for each customer. Therefore, the information provision system like the above invention applies to such substantial business activities as suggestions are offered corresponding to needs of customers.

However, products such as electronic devices and the like are components composing products. Therefore, retrieving information regarding components from a product in addition to obtaining information regarding each component is desirable, but conventional information service systems have difficulties in retrieving information from various categories that customers use in obtaining information.

In addition, custom-made products are developed while product developer needs are matched with customer needs. Therefore, to provide information including process information regarding a product and information regarding an upgraded product according to plans are required. There is thus a problem that conventional information service systems don't have the capacity to provide information regarding products corresponding to plans.

It is an object of this invention, in consideration of the problem described above, to display component information in association with the product, and obtain, efficiently and reasonably, information that customers require.

3. Disclosure of this Invention

The object described above is achieved by the invention comprising: a device information reception unit for receiving device information including component information that contains component identifier information, which identifies components composing a device, and image data displaying an image of said device; an information storage unit for storing component provision information including said component identification information; an information retrieval unit for retrieving the component provision information, which includes the component identification information that device information received by said device information reception unit includes, from said information storage unit; and a data generation unit for generating a display data from all or a part of said component provision information retrieved by said information retrieval unit, and said image data.

The present invention may be further characterized in that said component information includes position information, which indicates a display position on said image data, and wherein said data generation unit arranges all/a part of said component provision information on said image data corresponding to said position information which said component information contains, and generates a display data.

The present invention as may be still further characterized in that the information processing apparatus includes a display data transmission unit for transmitting the display data generated by said data generation unit.

The present invention as may be still further characterized in that the component provision information includes patent information related to said component.

The present invention as may be still further characterized as a terminal characterized by the information processing apparatus further including a device information transmission unit for transmitting device information to the information processing apparatus ; a data reception unit for receiving said display data transmitted from the information processing apparatus ; and a data display unit for displaying said display data received by said data receiving unit.

The present invention may be still further characterized as including an input reception unit for receiving a command to create a map, a product display list; a technological data storage unit for storing technological data, which contains more than one technological record including a technology identifier to identify technology and a product identifier to indicate annum and the product utilizing said technology; a data read unit for reading the technological record from said technological data storage unit, according to the command of composition received by said input reception unit; a layout determination unit for determining a display position of said technological identifier on the map, which has plural concentric circles that annum is modernized from core to a circumferential direction and that said plural concentric circles are divided into fan-shaped portions; a map creation unit for arranging said technology identifier on said display position calculated by said layout calculation unit, and creating said map; and a map output unit for outputting said map created by said map creation unit.

The present invention may be still further characterized as including a device information retrieval step of retrieving device information including component information, which composes a device, and a view data, which is an image of said device; a component information retrieval step of retrieving component provision information, which includes component mark information that is contained in said component information retrieved in said device information retrieval step; a data generation step of generating display data from said component information provision and the view data retrieved in said component information retrieval step; and a data display step of displaying said display data generated in said data generation step.

The present invention may be still further characterized as said component information including position information, which indicates a display position on said view data, and wherein said data generation step, further comprising the steps of: arranging all or a part of said provided component information on said view data corresponding to said position information which said component information contain; and generating display data.

The present invention may be still further characterized as including a data read step of reading technological data which contains more than one technology record including a technological identifier to identify technology and a product identifier to indicate annum and a product utilizing said technology; a layout determination step of determining a display position of said technical identifier on the map, which has plural concentric circles that annum is modernized from core to circumferential direction and that said plural concentric circles are divided into fan-shaped portions, corresponding to said annum and said product identifier that the technology record read in said data read step contains; a map composition step of arranging said technological identifier on said display position calculated in said layout determination step, and creating said map; and a map output step of outputting said map created in map creation step.

The features described above allow business proposals to prospective clients to be done at a customer's site, to offer needs of a side which develops a device and needs of a side which provides components that constitute the device, each side attempting to make a better device.

The present invention may be still further characterized as including an information storage unit for storing device view data and information related to a component, which includes component information and/or information regarding a side providing a component; a data generation unit for generating data for a device component from the device view data and the information related to the component stored by said information storage unit; and a data for a device component output unit for outputting the data for the device component generated by said data generation unit, and wherein information related to the component is outputted by said data for the device component output unit, on the different display corresponding to whether said information related to the component includes information regarding the side providing the component.

The present invention may be still further characterized as including an information storage unit for storing a device view data and information related to a component, which contain component information and/or information regarding a side providing a component; a data generation unit for generating data for the device component from the device view data and the information related to the component stored by said information control unit; a data for a device component output unit for outputting the data for the device component generated by said data generation unit; a destination information storage unit for storing multiple destination information which indicate a destination of information: a destination information obtaining unit for obtaining the destination information stored by said destination information storage unit; and an information transmission unit for transmitting a part or all of said information related to the component to the destination which the destination information obtained by the destination information obtaining unit indicates, in the case that said information related to the component does not have information regarding the side providing the component.

The present invention may be still further characterized in that said destination information storage unit stores more than one group identifier to identify a group of a destination and one transmission information containing the destination information, and wherein, in the case that said information related to the component does not contain the information regarding the side providing the component, the timing to transmit a part of or all said information related to the component is different in every group identified by the group identifier stored by said destination information storage unit.

The present invention may be still further characterized in that said group identifier includes the first group identifier to identify the first group and the second group identifier to identify the second group, and wherein, in the case that said information related to the component does not contain information regarding the side providing the component, said information transmission unit transmits a part or all said information related to the component to the first group identified by the first group identifier, if said information related to the component still does not have the information regarding the side providing the component, to the second group identified by the second group identifier, and if said information related to the component still does not contain information regarding the side providing the component, further to the first group.

The present invention may be still further characterized as including an information storage unit for storing a device view data and information related to a component, which contain component information and/or information regarding the side providing the component; an access person administration unit to administrate an access identifier to identify an access person and a group identifier in a pair; an access condition storage unit for storing an access time condition information indicating accessible time, and a group identifier in a pair; an access information reception unit for receiving access information containing an access identifier; a group identifier retrieval unit for retrieving a group identifier from said access person administration unit corresponding to the access identifier which said access information contains, in the case that access information is received by said access information reception unit; an access time condition retrieval unit for retrieving the access time condition, matched with the group identifier retrieved by said group identifier retrieval unit; a determination unit for determining whether it is accessible corresponding to the access time condition retrieved by said access time condition obtaining unit; and an information related to a component output unit for outputting all or a part of information related to a component, in the case that determination by said determination unit is to be accessible.

The present invention may be still further characterized in that the information outputted by said information related to the component output unit is different corresponding to the group identified by said group identifier.

The invention may be still further characterized as a computer program for performing the following steps comprising: a step of generating a data for a device component from a device view data and information related to a component; a step of determining whether said information related to the component includes information regarding the side providing the component; a step of outputting the data for the device component, on the visual output display corresponding to the case that said information related to the component includes information regarding the side providing the component; and a step of outputting the data for the device component, on the visual output display corresponding to the case that said information related to the component does not include information regarding the side providing the component.

The present invention may be still further characterized as a computer program for performing the following steps comprising: a step of determining whether information related to a component includes information regarding a side providing a component; a step of obtaining destination information which indicates a destination of the information related to the component in the case that the information related to the component does not include information regarding the side providing the component; and a step of transmitting a part or all of the information related to the component to the destination which the destination information obtained in said step indicates.

The present invention may be still further characterized as a computer program for performing the following steps comprising: a step of determining whether information related to a component includes information regarding a side providing a component; a step of obtaining destination information, which indicates a destination of the information related to the component, and transmission information including a group identifier in the case that the information related to the component does not include information regarding the side providing the component; a step of retrieving the group identifier included in said transmission information; and a step of transmitting a part of or all information related to the component to the destination which the transmission information obtained in said step indicates, at different timing every group identified by the group identifier retrieved in said step.

The present invention may be still further characterized as a computer program for performing the following steps comprising: a step of determining whether information related to a component includes information regarding a side offering a component; a step of obtaining destination information, which indicates the destination of the information related to the component, and transmission information containing a group identifier, which includes the first group identifier and the second group identifier in the case that the information related to the component does not include information regarding the side providing the component; a step of transmitting a part or all of said information related to the component to the destination indicated in the destination information which the transmission information including the group identifier contains; a step of determining, after the appointed time passage of said transmission, whether the information related to the component includes still information regarding the side of providing the component; a step of transmitting a part or all of the information related to the component to the destination which the destination information including the second group identifier indicates if the information related to the component still does not include information regarding the side of providing the component after the appointed time passage of said transmission; and a step of transmitting a part or all of the information related to the component to the destination which the destination information including said first group identifier indicates, after the appointed passage of performing the step of transmitting the information related to the component to the destination indicated by the destination information including said second group identifier.

The present invention may be still further characterized as a computer program for performing the following steps comprising: a step of receiving access information including an access identifier to identify an access person; a step of retrieving a group identifier corresponding to the access identifier that said access information received in said step contains; a step of retrieving the access time condition that matches with the group identifier retrieved in said step; a step of determining, based on the access time condition retrieved in said step, whether the access person identified by the access identifier is accessible; and a step of outputting all or a part of the information related to the component containing component information and/or information regarding the side of providing the component in the case that the access person is accessible.

The present invention may be still further characterized as a computer program wherein different kinds of information are outputted, every group identified by said group identifier in the step of outputting all or a part of said information related to a component.

The present invention may be still further characterized as a method for information processing, comprising the steps of: generating a data for a device component from a device view data and information related to a component; determining whether said information related to the component includes information regarding the side providing the component; outputting the data for the device component on the visual output display corresponding to the case that said information related to the component includes information regarding the side providing the component; and outputting the data for the device component, on the visual output display corresponding to the case that said information related to the component does not include information regarding the side providing a component.

The present invention may be still further characterized as a method for processing information, comprising the steps of: determining whether information related to a component includes information regarding a side providing a component; in the case that the information related to the component does not include information regarding the side providing the component, obtaining destination information which indicates the destination of the information related to the component; and transmitting a part or all of the information related to the components to the destination which the destination information obtained in said step indicates.

The present invention may be still further characterized as a method for information processing comprising the steps of; determining whether the information related to the component includes information regarding the side providing the component; in the case that the information related to the component does not include information regarding the side providing the component, obtaining destination information which indicates the destination of the information related to the component, and transmission information containing a group identifier; retrieving the group identifier contained in said transmission information; and transmitting a part or all of the information related to the component to the destination which the transmission information obtained in said step indicates, at different timing every group identified by the group identifier retrieved in said step.

The present invention may be still further characterized as a method for information processing, comprising the steps of: determining whether information related to a component includes information regarding a side providing a component; in the case that the information related to the component does not include information regarding the side providing the component, obtaining destination information which indicates the destination of information related to the component, and transmission information including a group identifier, which contains the first group identifier and the second group identifier; transmitting a part or all of said information related to the component to the destination indicated by the destination information which the transmission information including the first group identifier contains; determining, after the appointed time passage from said transmission, whether information related to the component still does not include information regarding the side providing the component; in the case that the information related to the component still does not include information regarding the side providing the component, transmitting a part or all of said information related to the component to the destination which the destination information including said second group identifier indicates; and transmitting, after the appointed time passage from said transmission, a part or all of the information related to the component to the destination which the destination information including the first identifier indicates.

The present invention may be still further characterized as a computer program for performing the following steps, comprising the steps of: generating a data for a device component from information related to a component, which includes, in some cases, a device view data and information regarding the side of providing the component; determining whether said information related to the component, which indicates a condition in a process of inquiry to the component, includes information regarding the side providing the component; outputting the data to the device component, on the visually different output display corresponding to the case that said information related to the component includes information regarding the side providing the component; and outputting a data for a device component on the visually different output display corresponding to the case that said information related to a component does not include information regarding a side providing a component.

As above, there are merits that an understanding of component associated information becomes easy and preventing information from spreading more than necessary makes it easy not to give disadvantageous information regarding a company to a rival of the company.

### BRIEF DESCRIPTION OF THE DRAWING

FIG. 1 shows a schematic diagram indicating the device information provision system applied for an information processing apparatus in one embodiment of the present invention;

FIG. 2 shows a block diagram indicating a hardware configuration of an information processing apparatus in one embodiment of the present invention;

FIG. 3 shows a flowchart indicating a method of providing information regarding an information processing apparatus in one embodiment of the present invention;

FIG. 4 shows a flowchart indicating a method of retrieving device information from a consumer terminal in one embodiment of the present invention;

FIG. 5 shows a flowchart indicating a method of arranging display in an information processing apparatus in one embodiment of the present invention;

FIG. 6 shows a diagram indicating an example of display data of a device;

FIG. 7 shows a diagram indicating an example of component information included in device information;

FIG. 8 shows a diagram indicating an example of component provision information stored by an information storage unit;

FIG. 9 shows a diagram indicating an example of a display data generated by a data generation unit of an information processing apparatus in one embodiment of the present invention;

FIG. 10 shows a diagram indicating a display aspect of component provision information displayed by a display data;

FIG. 11 shows a block diagram indicating a hardware configuration of a map creation unit of an information processing apparatus in one embodiment of the present invention;

FIG. 12 shows a flowchart indicating a method of creating a technology map by a map generation unit;

FIG. 13 shows a diagram indicating an example of technological data stored in a database;

FIG. 14 shows a diagram indicating an example of a technological map created by a map generation unit;

FIG. 15 shows a diagram for explaining a concept of the first embodiment.

FIG. 16 shows a diagram indicating an example of functional block of the first embodiment;

FIG. 17 shows a diagram indicating an example of component information regarding the embodiment;

FIG. 18 shows a diagram indicating an example of a device display data of the embodiment;

FIG. 19 shows a diagram indicating an example of information regarding a side that provides components in the embodiment;

FIGS. 20(a) and 20(b) show diagrams indicating an example of functional block in the first embodiment;

FIG. 21 shows an example of a flowchart of a process in the first embodiment;

FIG. 22 shows a diagram indicating a concept in a second embodiment;

FIG. 23 shows a diagram indicating an example of functional block in the second embodiment;

FIG. 24 shows an example of a flowchart of a process in the second embodiment;

FIG. 25 shows a diagram indicating a concept of a third embodiment;

FIG. 26 shows a diagram indicating an example of functional block of the third embodiment;

FIG. 27 shows a diagram indicating an example of functional block of an information transmission unit in the third embodiment;

FIG. 28 shows an example of a flowchart of a process of the third embodiment;

FIG. 29 shows a concept diagram indicating a fourth embodiment;

FIG. 30 shows a diagram indicating another concept of the fourth embodiment;

FIG. 31 shows a diagram indicating another concept of the fourth embodiment;

FIG. 32 shows an example of a flowchart of a process of the fourth embodiment;

FIG. 33 shows a diagram indicating a concept of a fifth embodiment;

FIG. 34 shows a diagram indicating an example of functional block of the fifth embodiment;

FIG. 35 shows an example of a flowchart of a process of the fifth embodiment;

FIGS. 36(a) and 36(b) show diagrams indicating a concept of a sixth embodiment;

FIG. 37 shows a diagram indicating an example of functional block of the sixth embodiment;

FIG. 38 shows a diagram indicating an example of a permission table of disclosure of information related to a component of the sixth embodiment;

FIG. 39 shows a diagram indicating an example of condition information regarding a seventh embodiment;

FIGS. 40(a) and 40(b) show diagrams indicating an example of a configuration of information related to a component in the seventh embodiment;

FIG. 41 shows a diagram indicating an example of condition information regarding the seventh embodiment;

FIG. 42 shows a diagram indicating an example of a display of condition information the seventh embodiment;

FIG. 43 shows a diagram indicating an example of a display of condition information regarding an eighth embodiment;

FIG. 44 shows a diagram indicating an example of other display of condition information regarding the eighth embodiment; and

FIG. 45 shows an example of a flowchart of a process of the eighth embodiment.

### DESCRIPTION OF THE PREFERRED EMBODIMENTS

The preferred embodiments of the present invention are in detail described as referred to the figures as follows.

An example of a device information provision system to provide device information, which is an electronic device product and the like constituting a product, is described in this embodiment.

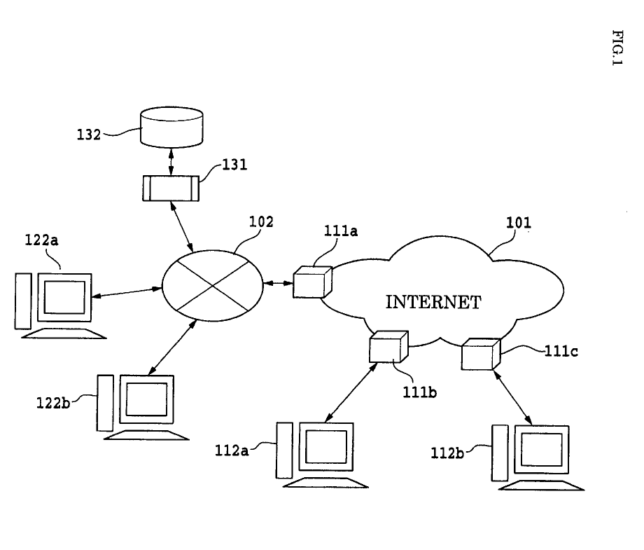

FIG. 1 shows a schematic diagram indicating a device information provision system that utilizes an information processing apparatus in this embodiment. The device information provision system is utilized in the internet 101 or the intranet 102 connected to the internet 101 via the gateway 111a. The internet 101 is, via the gateway 111b and 111c, connected to the customer terminal 111a and the customer terminal 112b for a customer who utilizes the device information provision system. On the other hand, the intranet 102 is connected to the company terminal 112a and terminal 112b that are terminals for a side of providing information.

In addition, the intranet 102 is connected to the server 131 that is an information processing apparatus in this embodiment. The server 131 is connected to the database 132 that stores component provision information or a technological data.

In the above, the component provision information or the technological data is stored in the database 132 from the company terminal 122a and 122b via the server 131. A client utilizing a device information service system accesses, via the gateway 111a, 111b, and 111c, the server 131 from the client terminal 112a and 112b and retrieves component provision information or technological data stored in the database 132.

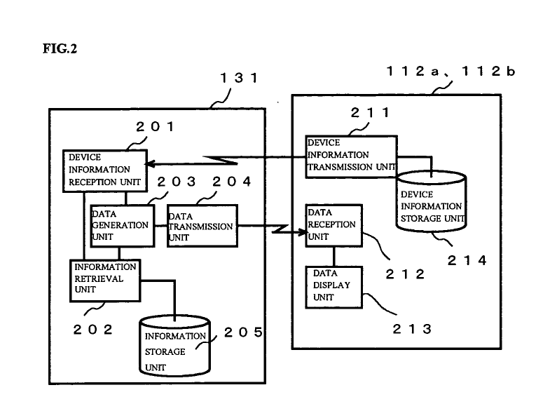

FIG. 2 shows a block diagram indicating an information processing apparatus in this embodiment. The server 131 comprises: the device information reception unit 201 which receives device information and an image data related to a device that a client demands; the information retrieval unit 202 which retrieves information from the information storage unit 205 according to the received device information; the data generation unit 201 which edits the retrieved information and device display data and generates display data that is provided for a client; the data transmission unit 204 which transmits the edited data to the client terminal 112a and 112b via the internet 101 and the gateway 111a.

Further, component provision information is stored with the information storage unit 205 in the server 204 in this embodiment, but may be stored also with the database 132 that is accessed by the server 131.

On the other hand, the client terminal 112a and 112b comprises: a device information transmission unit which transmits, to the server 131, a device information and a device display data related to a device that a client demands; the data reception unit 212 which receives the display data from the server 131; the data display unit 213 which display the received display data. In addition, the client terminal 112a and 112b comprises the device information retrieval unit 214 and are accessed to the device information transmission unit 211.

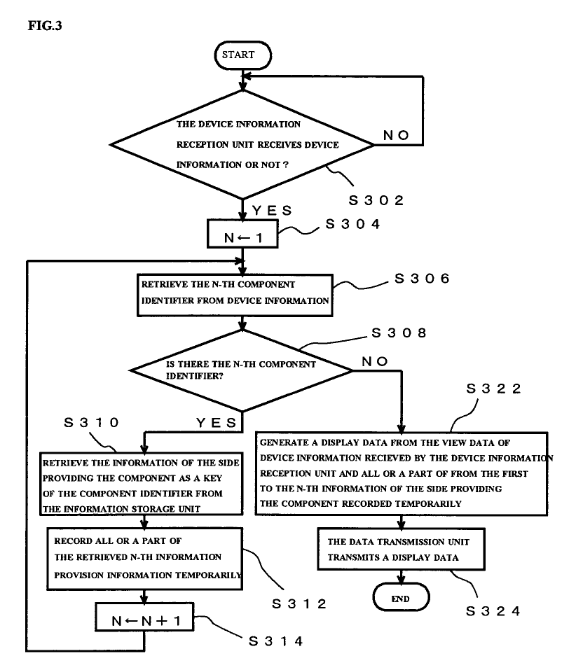

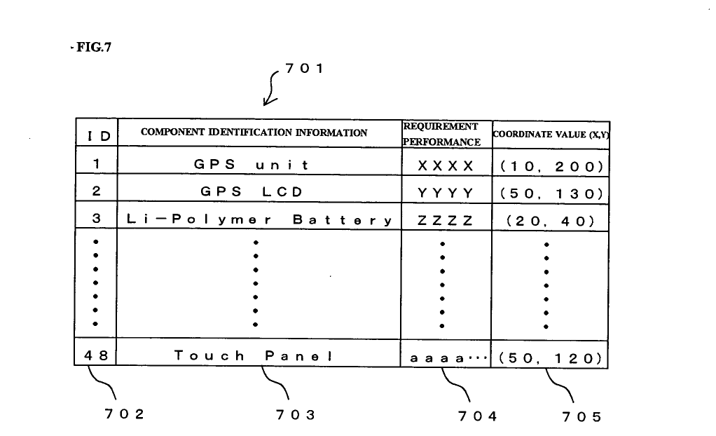

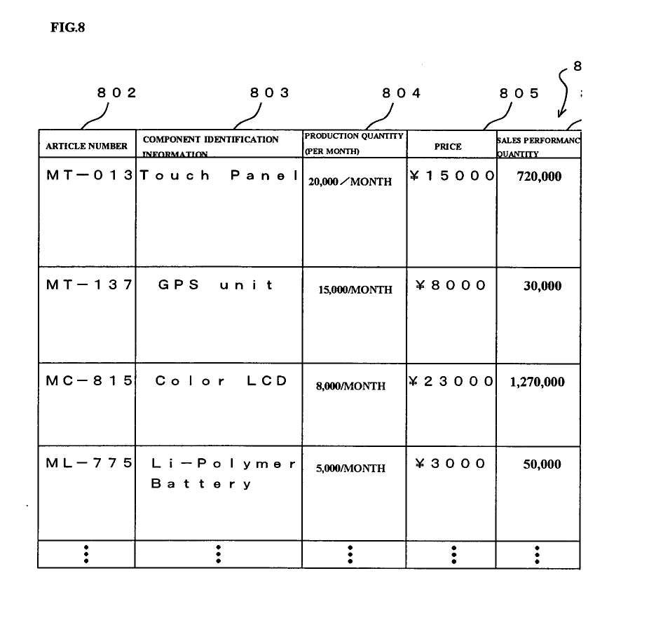

FIG. 3 shows a flow chart indicating an algorithm of information provision of an information processing apparatus in this embodiment. The server 131, the information processing apparatus in this embodiment, receives device information from the client terminal 112a and 112b (S302) in the device information unit 201 and transfers said information to the device information storage unit 202. The information retrieval unit 202 refers to a table stored in the information storage unit and retrieves a component identifier of a component included in a device that a client demands, from component information (below described in FIG. 7) that the received device information includes. (S306) The information retrieval unit 202 retrieves component provision information (below described in FIG. 8) as a key of a component identifier from the information storage unit 205 and temporarily stores all or a part of the retrieved component provision information. (S322)

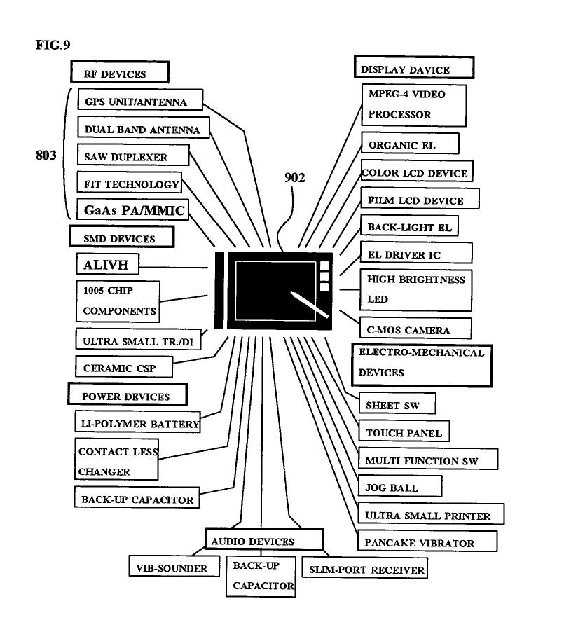

As the retrieval of the component identifier included in a device is completed (S308) , the information storage unit 202 temporarily transfers stored component provision information to the data generation unit 203. Display data of device information, which is received in the device information reception unit 201, is also transferred to the data generation unit 203, and the data generation unit 203 edits the data and information and generates a display described in FIG. 9 (S322). The generated display data is transmitted from the transmission unit 204 to the client terminal 112a and 112b.

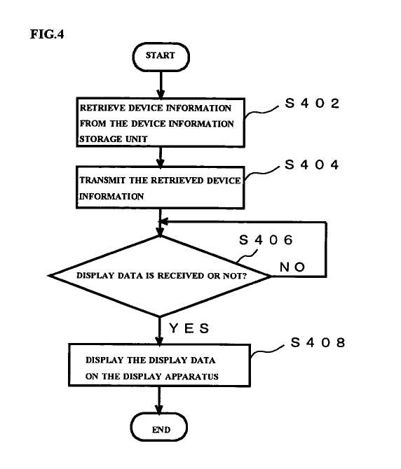

FIG. 4 shows a flow chart indicating an algorithm of retrieving device information from a client terminal in a device information provision system. The client terminal 112a and 112b retrieve device information and a display data related to a device that a client demands (S402) , and transmit them to the server 131 (S404) The server 112a and 112b depend on transmission of display data from the server 131 (S406) and display the display data in the display unit 213 (S406).

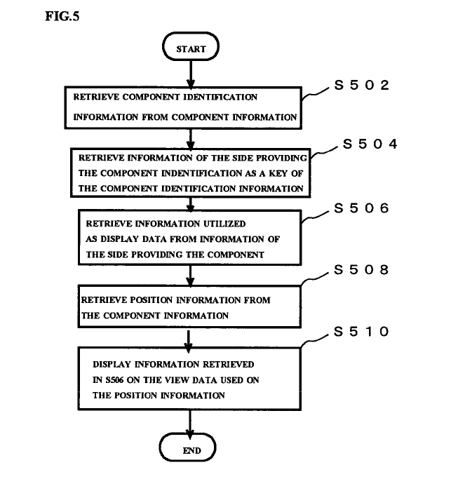

FIG. 5 shows a flow chart indicating algorithm of editing display data in an information processing system in this embodiment. The data generation unit 203 retrieves component provision information as a key of a component identifier from the information storage unit 205 (S504) and retrieves information, which is utilized as display data, from the retrieved component provision (S508) . Further the data generation unit retrieves destination information from the retrieved component provision information. The data generation 203 arranges the information retrieved in S506 on the display data of a device that a client demands on the basis of the destination information obtained in S508 (S510).

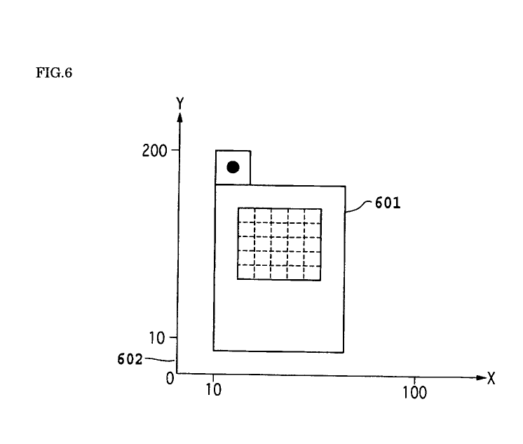

FIG. 6 shows an example of display data of a device. For example, the display data indicated in the display data 601 is an image, which is viewed on the front of a portable terminal. The display data 601 includes display data and position information, which are displayed on a specific position of the coordinate 602 indicating a display range in the display data generated by the data generation unit 203.

The display data 601 is received in the device information reception unit 201 with the device information by the client terminal 112a and 112b, and is transmitted to the data generation unit 203 with the component provision information and position information obtained in information retrieval unit 202. The data generation unit 203 edits the component provision information utilized in a portable terminal in the display data 601 on a basis of the coordinate 602, and generates the display data described in FIG. 9.

FIG. 7 shows an example of component information included in device information. The component information includes component information related to the component constituting the device. The component information unit 701 comprises: the component identification information 702, which are the ID 702 utilized as a component identifier to determine the component and the name of the component; the requirement performance 704 that a specification of a component and the like are described therein; the coordinate value 705, which is position information indicating the display position on the coordinate 603.

As the information retrieval unit 202 retrieves device information in the device information reception unit 201 from the client terminal 112a and 112b, the information retrieval unit 202 refers to a table stored by the information storage unit 205, retrieves the component information 701 from the receiving device information, and retrieves component provision information from the information storage unit 205 on a basis of the ID 702 or the component identification information 703.

FIG. 8 shows an example of component provision information stored by an information storage unit. The component provision information 801 stored in the information storage unit 205 includes the article number 802 utilized as a component identifier to specify a component and the component identification information 803, which is a component name. The information retrieval unit 202 retrieves the component provision information 803 from the information storage unit 205 based on the article number 802 or the component identification information 803.

In addition, the component provision information 801 includes the production quantity 804 indicating production quantity per month, the price 805 and the past sales performance quantity 806 as the detailed information related to a component. The detailed information related to the component can store various kinds of information, such as the detailed specifications of measure, weight or durable years.

Furthermore, the component provision information 801 includes the related patent number 807 and the patent description 808 as patent information related to a component. The client's possession of the patent information makes it possible to retrieve information based on a patent number and easily obtain information on necessity of license agreement related to a component utilized by the client.

FIG. 9 shows a display data generated by a data generation unit in an information processing apparatus in this embodiment. FIG. 9 shows the display data 901 generated by the data generation unit 203 in the server 131 when a client demands device information regarding the portable terminal 902 from the server 131. The display data, that is the image viewed on the front of the portable terminal 902, is shown centrally.

The component identification information 803 that is retrieved from component provision information regarding a component utilized in the portable terminal 902 is shown in the perimeter. The component identification information 803 is arranged in association with a display data based on the coordinate value 705 and the coordinate 602.

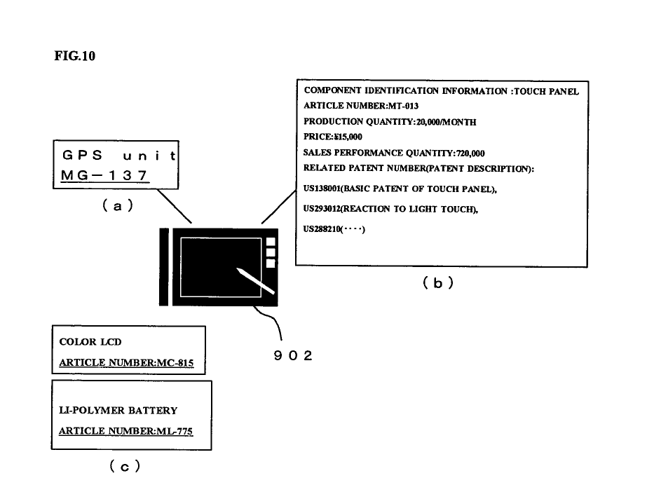

FIG. 10 shows a display appearance of component provision information displayed on the display data. FIG. 10(a) shows the arrangement of the component identification information 801 and the article number 802 in association with the display data of the portable terminal 902 based on the coordinate value 705 and coordinate 602. FIG. 10(b) shows the arrangement of all the component provision information 801, such as the component identification information in association with the display data of the portable terminal 902 based on coordinate value 705 and coordinate 602. FIG. 10(c) shows the arrangement of the component identification information 803 and the article number 802 in a voluntary perimeter of an image data without referring to the coordinate value 705.

In this way, the data generation unit 203 edits the component provision information 801 and image data, and generates display data. In addition, various kinds of appearance of component provision information are described and do not matter whether the appearance includes the coordinate value 705, which is position information to arrange a component identifier.

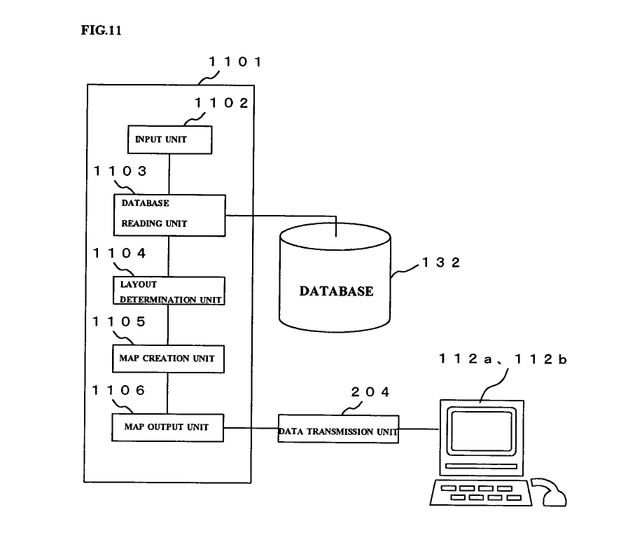

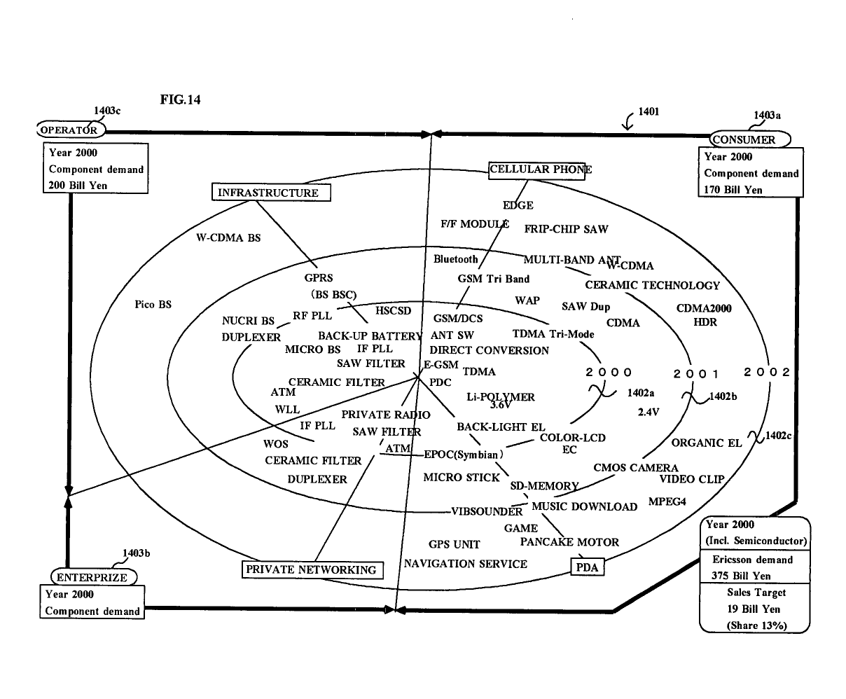

FIG. 11 shows a block diagram indicating hardware configuration of a map creation unit in an information processing apparatus in this embodiment. The map creation unit 1101 comprises: the input unit 1102, which receives a demand of creating a technological map of a device described later in FIG. 14; the data base reading unit 1103, which retrieves technological data, which is necessary for creation of a technological map from the data base 132; the layout determination unit 1104, which determines a display position on the technological map of a device from the read technological data; the map creation unit 1105, which creates a map according to the determined position; the map output unit 1106 outputting the created map.

When the map output unit 1106 is connected to the data transmission unit 204 in the server 131, the created map is transmitted to the client terminal 112a and 112b via the Internet 101 and the gateway 111a by the data transmission unit 204, and is displayed on a data display unit.

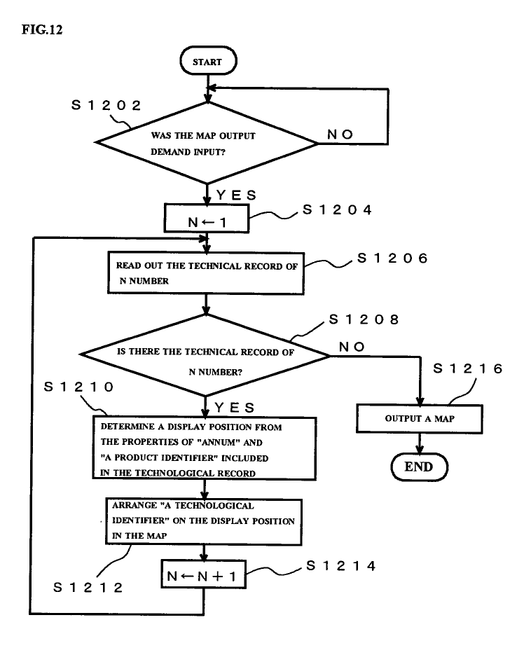

FIG. 12 shows a flow chart indicating an algorithm of creation of a technological map in a map creation unit. The server 131 receives a demand or request for creation of a technological map of a device from the client terminal 112a and 112b in the input unit 1102 (S1202) , and the data base read unit 1103 retrieves each record of the technological data stored in the data base 132 (S1206). The layout determination unit 1104 determines a display position on a technological map from the properties of “annum” and “a product identifier” included in the read technological data (S1210). The map creation unit 1105 specifies a technology identifier indicating technical field of a product based on a map frame of the foundation of a technological map, and arranges a product identifier on a determined display position (S1212).

The fixed map frame, which is stored in advance, may be utilized as a map frame. In addition, whenever a map is created, it is impossible to create a frame of map according to more than one product identifier. A technology identifier is arranged so as not to be accumulated in a field of a product identified in said product identifier.

When all arrangements of product identifiers of a device included in a technological data are finished (S1208), the map output unit 1106 transfers a created map to the data transmission unit 204 (Sl2l6) , and the data transmission unit 204 transmits it to the client terminal 112a and 112b.

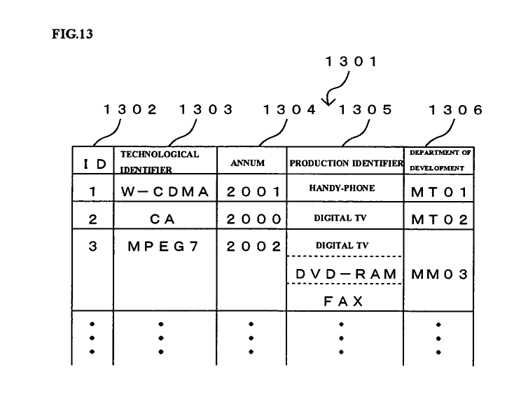

FIG. 13 shows an example of technological data stored in a database. The technological data 1301 stored in the database 132 comprises the ID 1302 utilized to specify technology, the technological identifier 1303 indicating a technological field of a product, the product identifier 1305, which is the annum 1304 indicating a property of a product and a name of the product and the development post 1306, which is a name of the post in charge of development of a product. The technological data 1301 stores the product identifier 1305 as a record for each product identifier 1305.

The layout determination unit 1104 determines a display position on a technology map for every product identifier 1305 from the annum 1304 and the product identifier 1305 included in the technological data 1301. The map creation unit 1105 is identified by the technological identifier 1303 indicating a technological field of a product on a basis of a map frame, which is the foundation of a technological map, and arranges the product identifier on the determined display position.

FIG. 14 shows an example of a technological map generated in a map creation unit. The technological map 1401 displays a list of devices of the person providing device information in a frame of concentric circle. In addition, the plural concentric circles 1402a to 1402c are divided into fan-shaped portions 1403a to 1403c, and are classified under a technological field of a product indicated by the technological identifier 1303. The map creation unit 1105 is identified by the technological identifier 1303 on the basis of a map frame, which is the foundation of the technological map 1401, arranges the product identifier 1305 in a display position determined by the layout determination unit 1104 and creates the technological map 1401.

Next, the first embodiment is described below.

This embodiment is an information processing apparatus characterized by an output configuration, which makes it impossible to initially decide whether or not there is a person who can provide a component utilized in a device when a data for device component generated from a device view data and information related to a component is outputted on the visual display.

“A device view data” and “a view data” have the same meaning in this specification. “A device view data” or “a view data” is the dimension of data to display a view, which is not limited to a bit map image data and includes various kinds of configurations such as text data, graphical data and the like.

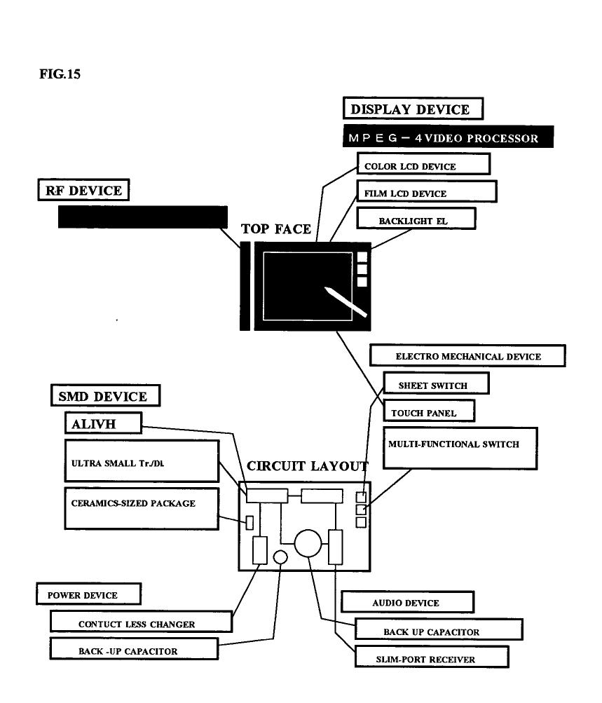

FIG. 15 shows an example of an output configuration of this information processing apparatus. “GPS unit/Aerial” and “MPEG-4 video processor” are, as shown in this figure, represented on an inverse display in monochrome. This component represented on an inverse display in monochrome is a component that does not have a person to provide the component. Other components represented in black letters with white background are components that have a person to provide the component.

In this way, at the first sight, it is convenient that a component that has a person providing it is distinguished from a component that does not a person providing it.

For example, when a new product is planned, and a presentation is made, this information processing apparatus makes early preparation of a plan and understanding of a person who is presented impossible by easily distinguishing which components are key.

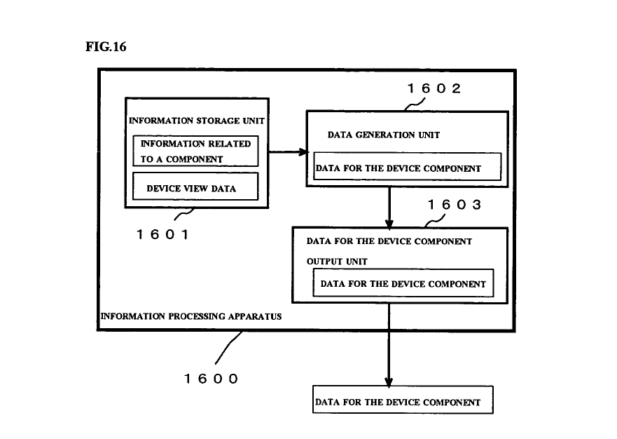

FIG. 16 shows an example of a functional block diagram of this information processing apparatus. As shown in this figure, this information processing apparatus 1600 comprises the information storage unit 1601, the data generation unit 1602 and the data for a device component output unit 1603. The information storage unit 1601 stores device view data and information related to a component. The information related to a component includes component information and/or information regarding a side providing a component.

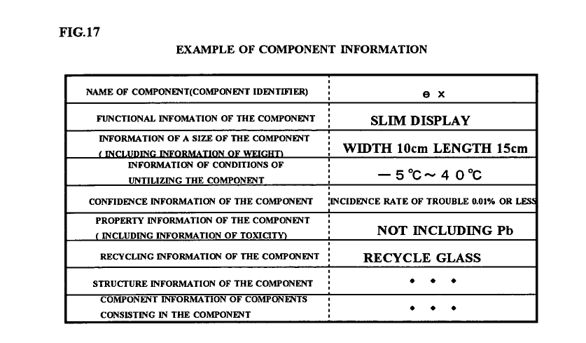

FIG. 17 shows an example of “component information”. “Component information” is information related to a component, which is, for example, a title of a component (a component identifier) , function information regarding a component (for example, a thin model of a display), size information regarding a component (for example, 10 centimeters wide, 15 centimeters long) as shown in this figure.

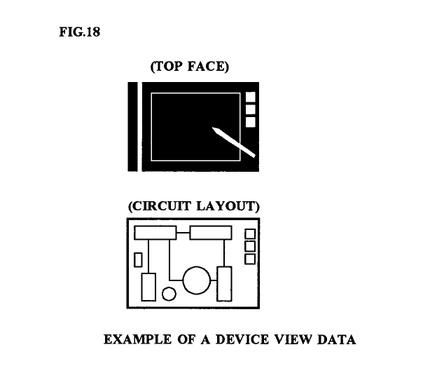

FIG. 18 shows an example of a device view data. As shown in this figure, a device view data may not only include data showing appearance, but also data showing internal structure.

The relation between a device view data and component information is the relation that the latter included in the former constitutes the whole.

A data generation unit generates data for a device component from device view data and information related to a component stored in said information storage unit. For example, “a data for a device component” comprises not only a data comprising information regarding a device and a component according to the device, but, in some cases, data showing a part of utilizing a component in a device view data as a place.

In this way, the corresponding relation between a component and a device becomes visually clearer.

A data for a device component output unit outputs a data for the device component generated by said data generation unit. “An output” includes various kinds of output configurations, which are transmissions, printouts, representations on a display, etc. It is suitable for a visual output. Therefore, this data for the device component output unit may not include an output device, and, if it does not include an output device, but includes an output measure of an output device. “An output device” is a modulator demodulator, a printer, a display and, or “an output measure” is a driver such as a modem.

And this data for the device component output unit is characterized by the visually different display of an output of said information related to component corresponding to whether said component associated information includes component offer side information.

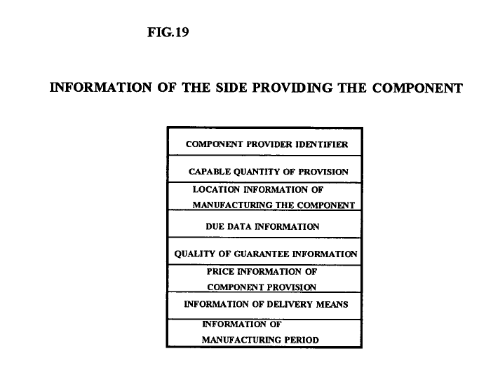

FIG. 19 shows an example of information regarding a side providing a component. As shown in this figure, information regarding a side providing a component can include “a component provider identifier”, “possible quantity of provision”, “a manufacturing location information”, “due date information”, “quality guarantee information”, “component provision price information”, “delivery means information”, “manufacturing period information”, etc. of course it is not required to include all of these.

The visually different configuration of an output corresponding to whether or not information related to a component includes information regarding a side providing a component can decide, at first sight, whether there is a person who can provide the component. Among the examples of the above-mentioned information regarding providing the component, presence of a component provider identifier corresponds with presence of person who can provide the component

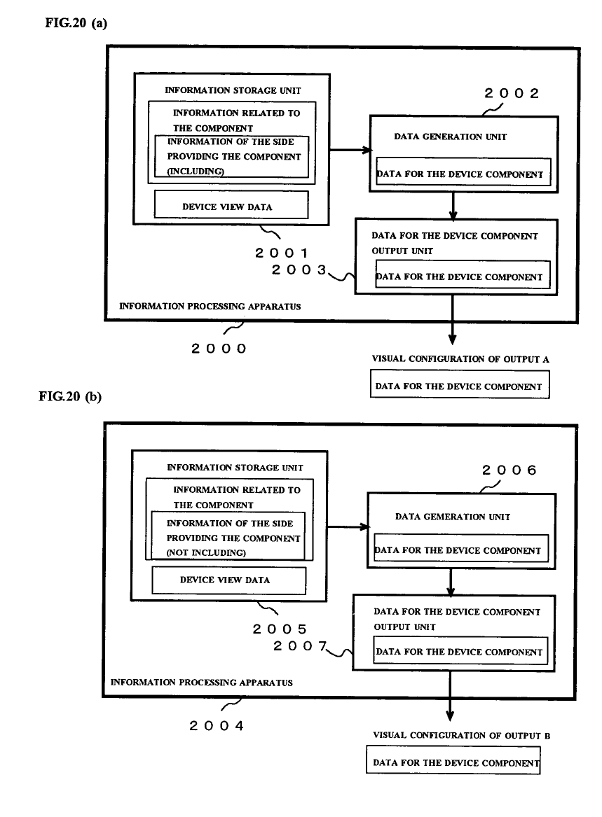

FIGS. 20(a) and 20(b) show diagrams indicating a visually different configuration of the data for device component output unit 2003 corresponding to whether this information regarding the side providing the component is included or not. As in the information processing apparatus 2000 in FIG. 20(a), the information related to a component stored in information storage unit 2001 is “information regarding a side of providing a component (is included)” include information regarding a side of providing a component, an output by the data for a device component output unit 2003 via the data generation 2002 is the visual output configuration “A” corresponding to the case in which the information regarding the side providing the component is included.

On the other hand, as in the information processing apparatus 2004 in FIG. 20(b), the information related to a component stored by the information storage unit 2005 is “information regarding a side providing a component (not included)” (not including information regarding a side providing a component), an output by the data for device component output 2007 via the data generation unit 2006 is the visual output configuration “B” corresponding to the case that the information regarding the side providing the component is not included. The output configuration “A” and “B” are each different output configuration in the present invention each. To be concrete, in addition to the configurations shown in said FIG. 15 there are such various kinds of visual output configuration as one output configuration expresses a regular display and the other expresses letters indicating a component by blinking, and one output configuration expresses a regular display and the other expresses letters indicating a component in light colors.

The case in which the visual output configuration is different is shown herein, the case in which a component without information regarding a side providing a component is verbally informed in a voice, for persons having a visual handicap, is considered.

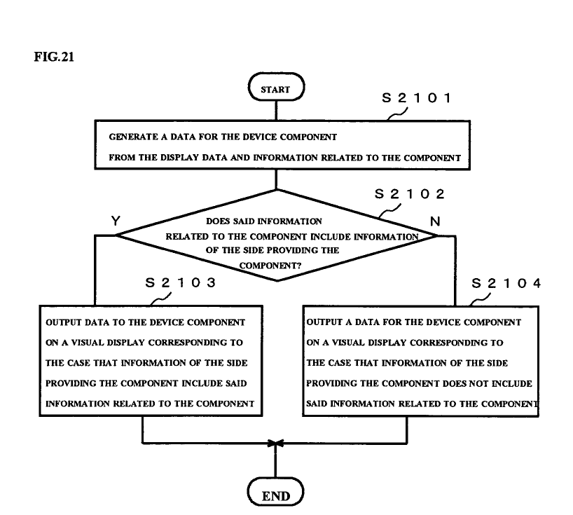

FIG. 21 shows a flow chart indicating a process in this embodiment. First of all, in the first step, data for a device component is generated from a device view data and information related to a component (Step S2101). Next, in the second step, whether said information related to the component includes information regarding a side providing a component is determined (Step S2102). In the third step, when the component of the side providing the component is included, the data for the device component is outputted on the visual output configuration corresponding to the case in which the information regarding the side providing the component includes said information related to the component (Step S2103). When the component of the side providing the component is not included, the data for the device component is outputted on the visual output configuration corresponding to the case in which the information regarding the side providing the component does not include said information related to the component (Step S2104). Completing an output finishes the process.

This process may be put into operation as a computer program that can be performed and a recording medium that records the program. Since the above is the same throughout the description, subsequent descriptions have been omitted and the above is stated every time when flows of processes are explained.

The second embodiment refers to transaction ordering a component when there is not a component of a side providing information.

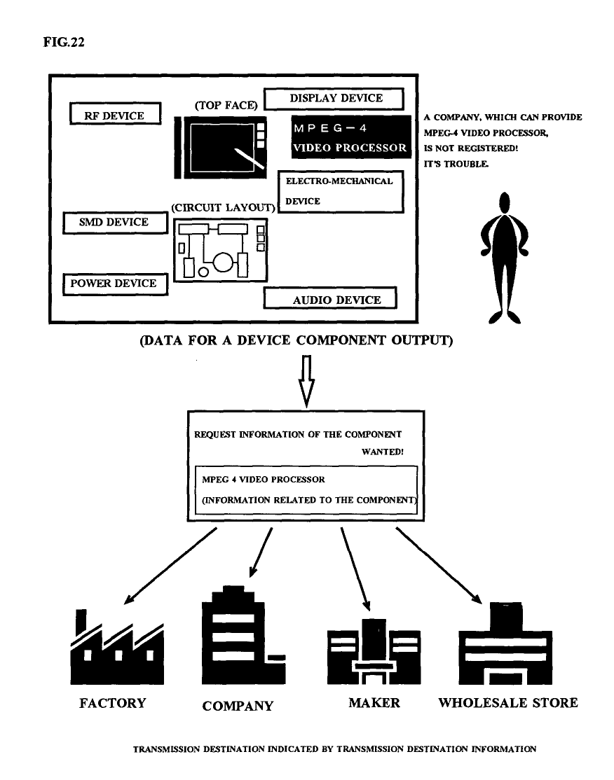

FIG. 22 shows a schematic diagram of this embodiment. As explained following this figure, for example, it is supposed that a project meeting related to a certain electronic device is being held, by utilizing this information processing apparatus. In this case, “MPEG 4 video processor” is displayed on a visual configuration easy to watch as a component that does not have information regarding a side providing a component. The chief of the product meeting who views the display is embarrassed by the case that companies that can provide a component are not registered at the present time. However, this information processing apparatus transmits, by an electronic mail and other means, information including information related to a component that has a property of information regarding desiring a component to a specific sending destination, based on a component that does not have information regarding a side providing a component. Then, the provision of the component can be predicted by getting a reply such as “in preparation of deliveries at the present time” and the like from a sending destination.

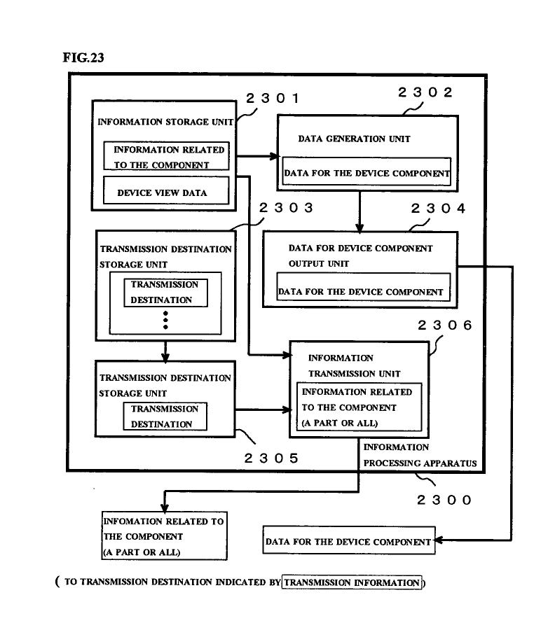

FIG. 23 shows an example of a functional block diagram of an information processing apparatus of this embodiment. As shown in this figure, this information processing apparatus 2300 is common to an information processing apparatus of the embodiment 1 in respect of having the information storage unit 2301, the data generation unit 2302 and the data for a device component output unit 2304. In this embodiment, the transmission destination information storage unit 2303, the transmission destination information retrieval unit 2305, information transmission unit 2306 is added to said embodiment 1.

The transmission destination storage information unit 2303 stores more than a transmission destination information indicating a destination of transmitting information. Here, “information” indicates a part of or all information related to a component, and “transmission destination” indicates an address of a side transmitting a part of or all this information related to the component. The reason of such a transaction as above described is why it is desirable that a provider of a component is announced by transmitting a part or all information related to a component to said “transmission destination”. Therefore, “transmission destination” is a side expecting provision of a component indicated by information related to a component.

“A part of or all information related to a component” is not “all information related to a component” because the information related a component includes, in some cases, confidential information. Of course, secret information is not always included, so that all information related to a component is an object of transmission.

The transmission destination information retrieval unit 2305 retrieves transmission information stored by said transmission destination storage unit 2303. In the case that a part or all of specific information related to a component is not transmitted to the information transmission destination, the transmission destination retrieval unit 2305 retrieves transmission destination information regarding a side, which should transmit a part or all of specific information related to a component, from transmission destination information stored by said transmission destination information storage unit 2303. Here, transmission destination information is an electronic mail address, a global IP address, a FAX number, a telephone number or an address. Therefore, a concept of “transmission” does not only include an electronic transmission, but also “a printout of an address for mailing” in some cases.

In the case that said information related to a component does not include information regarding a side providing a component, the information transmission unit 2306 transmits part or all of said information related to a component to transmission destination information retrieved by said transmission destination information retrieval unit. In the case that information regarding a side providing a component does not include information related to a component, it is necessary that a provider is determined immediately because a provider of a component is not fixed in some cases.

Further, this transmission may be performed by the information processing apparatus 2300 automatically, and in response to a person's direction.

For example, selecting a component identified visually by a data for a device component outputted by the data for the device component output unit 2304 (not associated with information regarding a side providing a component), selecting can be done with a mouse and a display screen, following a pull-down menu such as “look for an outside component provider” may be utilized as initialing transmission.

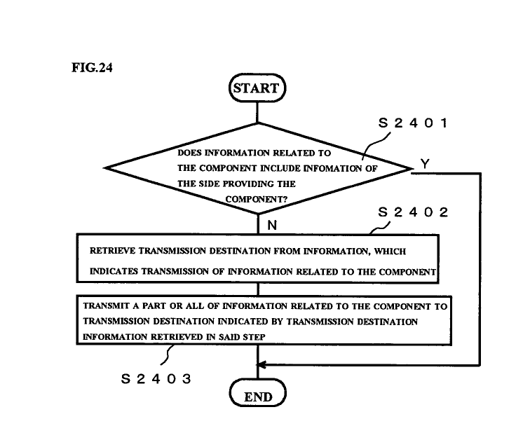

FIG. 24 shows a flow of a process of the embodiment 2. As shown in this figure, in the first step it is determined whether information related to a component includes information regarding a side providing a component (Step S2401). If the result is the case of including the information regarding the side providing the component, the process is finished. If the result is the case of not including the information regarding the side providing the component, in the second step transmission destination information, which indicates a transmission destination of information related to a component, is retrieved (Step S2402). In addition, in the third step a part or all of the information related to a component is transmitted to a transmission destination indicated by transmission destination information retrieved in said step, so that the process is finished. When component associated information has component offer side information as a result of a decision, the process is finished. Further, if there are plural components, the same process for all the components is repeated. A process in the case that there are plural components is not especially referred to in this description because the process is the same, so that the process is not repeated.

Next, this third embodiment is characterized in that a part or all information related to a component is transmitted at different timing to a corresponding group into which the transmission destination is divided. For example, the group may be determined corresponding to a purpose such as one company group developing a device, a new product, and others, and a domestic group and a group in a foreign country.

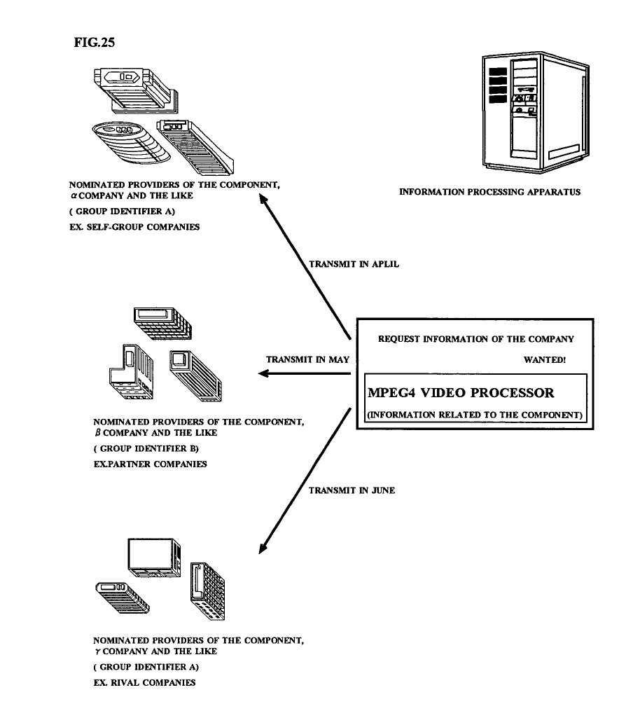

FIG. 25 shows a schematic diagram of the embodiment 3. For example, it is supposed that there are “a nominated provider of a component such as α corporation and the like (group identifier A)”, which is a company of the present group, “a nominated provider of a component such as β corporation and the like (group identifier B)”, which is associated with the present company (not a rival), “a nominated provider of a component such as λ corporation and the like( group identifier c)”, which is a rival of the present company.

It is expected that information related to a component indicating information associated with a plan of a new product or including the information which is withheld from other companies for as long as possible. In particular, the information is withheld from other companies, which are rivals of the present company, for as long as possible. Therefore, then information related to a component (a part or all of) is transmitted to “a nominated provider of a component such as corporation and the like ( group identifier A)”, which is a company of the present group, at the beginning of planning, in April, and after one month, in May, transmitted to “a nominated provider of the component such as β corporation and the like( group identifier B)”, which is associated with the present company( not a rival). Next, the information is transmitted “A nominated provider such as λ corporation and the like( group identifier c)”, which is a rival of the present company in June, which is the last time in the range that there is not an obstacle in performing the plan.

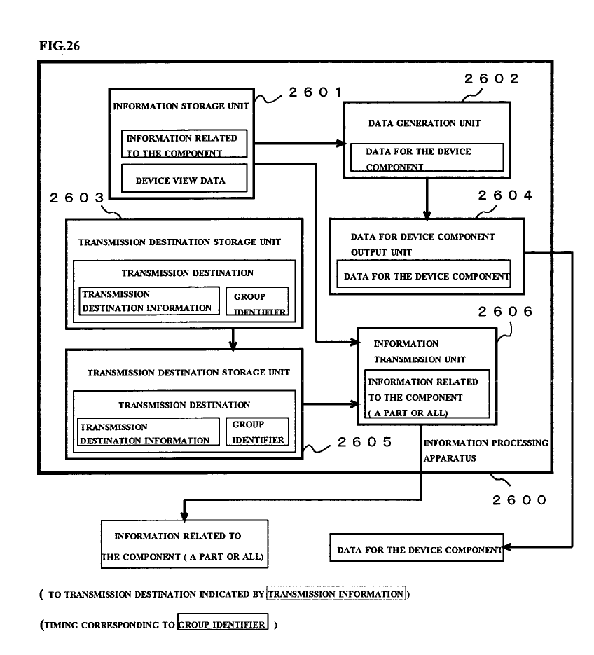

FIG. 26 shows an example of a functional block diagram indicating an information processing apparatus of this embodiment. As shown in this figure, this information processing apparatus 2600 contains the information storage unit 2601, the data generation unit 2602, the data for a device component output unit 2604, the transmission destination storage unit 2603, the transmission destination information retrieval unit 2605 and the information transmission unit 2606 as the common units to the embodiment 2.

This embodiment is characterized in that said transmission destination information storage unit 2603 stores more than a group identifier identifying a group of transmission destinations and one transmission information including transmission destination information. And in the case that said information related to a component information does not include information regarding a party providing a component, a part or of said information related to the component is transmitted by said information transmission unit 2606 at different timing corresponding to every group identified by a group identifier stored by said transmission destination information storage unit 2603.

Here, “A group identifier” is a thing identifying a group of transmission destinations. For example, as above described, it is a group company (group identifier A) , a company which is coped (not a rival) with the group company (group identifier B), or a company which is a rival of the group company (group identifier C).

Of course, grouping identified by a group identifier is not limited to the above.

There is various kinds of grouping such as “a group of a foreign company and a group of a domestic company”, “a group of partnership companies and a group of non-partnership companies” or “a group of companies which have made transactions and a group of companies which have never made transactions”.

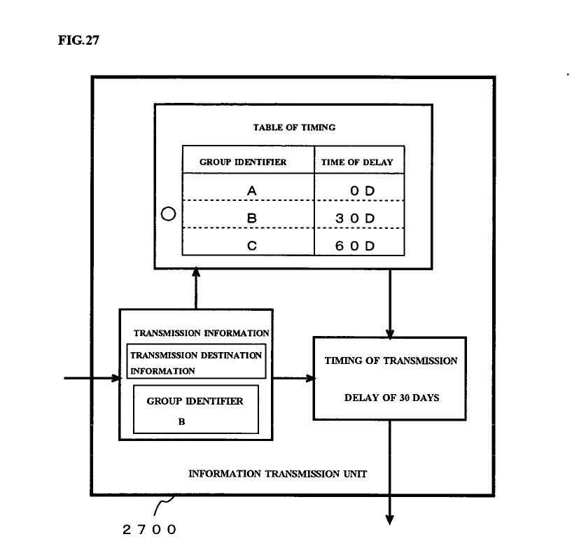

FIG. 27 shows a timing block diagram indicating a concrete structure that makes timing different. The information transmission unit 2700, in which a timing table is set up, retrieves the timing table and obtains the time corresponding to a group identifier that transmission information received by transmission destination information and the liked includes.

“Delay of time” indicates time delaying the time of the first transmission by a group identifier. A timing of transmission is set up corresponding to a delay of time obtained, so that a part or all of information related to a component is transmitted to transmission destination indicated by transmission destination information when it comes to the timing.

As shown in this figure, for example, delay of time defies a group identifier A as “0 days ”, a group identifier B as “30 days”, and a group identifier B as “60 days ”. Of course, since the purpose is to make the timing different, various kinds of timing may be determined not only by an index of delay of time, but also by appointing a specific time of transmission and the like.

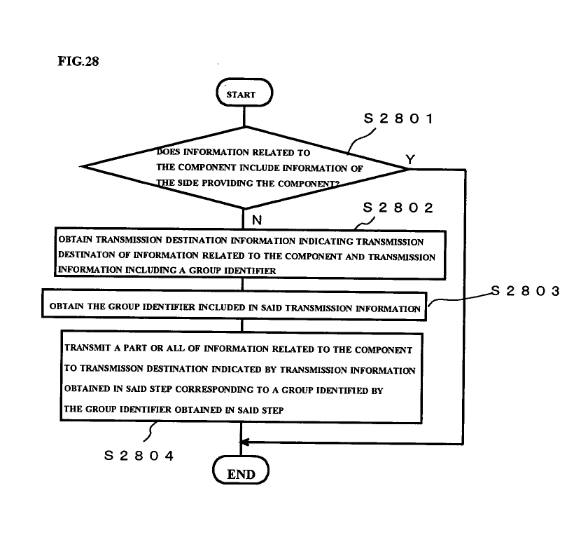

A scale of time, which makes “timing” different, may be any kind of scale such as “year, month, day, hour, minute, and second”. FIG. 28 shows a flow chart indicating a process of this embodiment. As shown in this figure, first, the first step it is decided whether information related to a component includes information regarding a party providing the component (Step S2801). If the information related to the component includes the information regarding the party providing the component, the process is finished. If the information related to the component does not include the information regarding the party providing the component, in the second step transmission destination information indicating transmission destination of information related to a component and transmission information including a group identifier are obtained (Step S2802). Next, in the third step a group identifier included by said transmission information is obtained (Step S2803) and in the forth step, a part or all of the information related to a component is transmitted at a different timing corresponding to a group identified by a group identifier obtained in said step (Step S2804). Then the process is finished.

Like the above, in this embodiment there are merits of controlling the disclosure of information in terms of time and superiority and of having information that is easily obtained. Further, in a real process, different timings are made by preparing a table, which determines timing for each group identifier and performing transmission base on the information regarding the timing, which is obtained for every group identifier.

In this fourth embodiment, transmission destination is divided into two groups, so that information related to a component is transmitted to the first group, and if the first group provides the component, the information related to the component is transmitted to the second group. Then, one of the aims of an information processing apparatus is feeding information to the first group and determine whether the second group can provide the component.

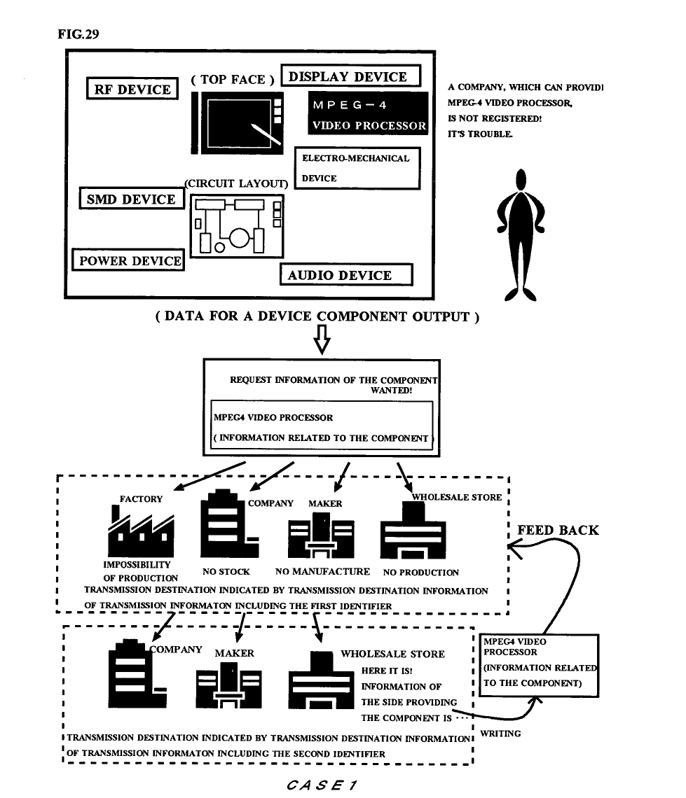

FIG. 29 shows a conception indicating the case that said second group (a group identified by a second identifier) can provide a component (CASE 1). For example, it is assumed that a company, which can provide “MPEG 4 video processor”, is not registered, while planning a new product by utilizing a data for a device component output for a device is noticed. Information related to the component is transmitted to transmission destination indicated by transmission destination information by the appropriate direction, which is transmitted to an information apparatus transmitted by the chief of planning. Of course, basically the above is preformed automatically, but the transmission may be operated by manually by the hand of the chief of planning.

In this case, at first a company, which is a group of the present company, or a partnership company, is retrieved as transmission destination including a first group identifier, and information is transmitted only to the information transmission. However, it becomes clear that any company, which includes this first group identifier, cannot provide this “MPEG 4 video processor”. (whether or not a company, which includes the first group identifier, makes, on a predetermined condition, some replay to an information processing apparatus makes this case “being clear”.) Then the information processing apparatus obtains the transmission destination of a company, which is in a rival with the present company and includes the second group identifier, and transmits a part or all of information related to a component to the information destination.

However, it become clear that one of companies including this second group identifier can provide “MPEG 4 video processor (whether or not a company, which includes the first group identifier, makes, on a predetermined condition, some replay to an information processing apparatus makes this case “being clear”).

Information regarding a party providing a component is added to information related to a component as described above. For example, a company itself transmits information that a component can be provided electrically to an information processing apparatus. The information related to the component added to the information regarding the party providing the component is fed back to a group of companies, which include said first group identifier. The group of companies, which are fed back and include the first group identifier, for example, obtain information that a rival company can provide a component which the present company can't provide, and, in some cases, think about the own preparation of developing the component and, in other cases, add the component to a product line map with province of OEM province by a rival company. Further, arrow-heads in the figure do not show the transmission dimensions nor the destination of information, but show only a flow chart of information. Information is transmitted by an information processing apparatus of the present invention.

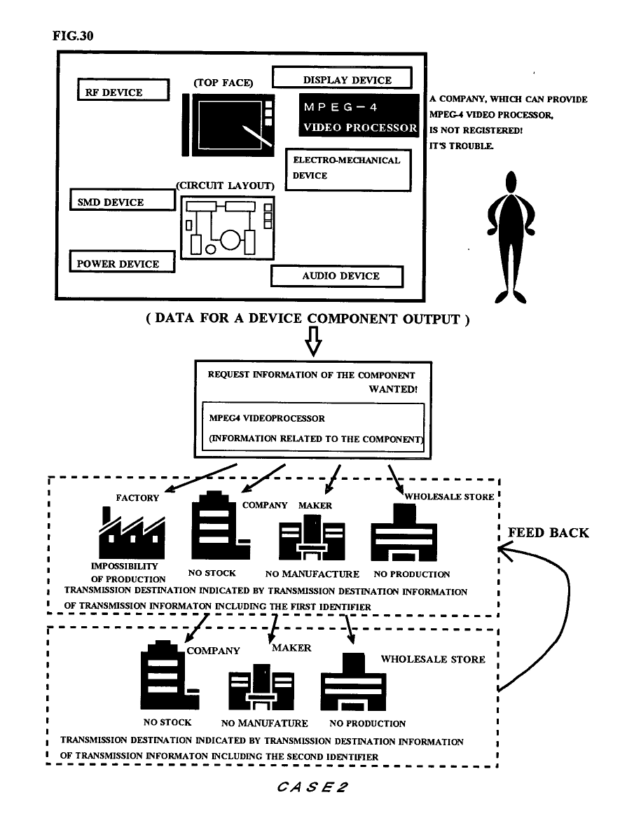

FIG. 30 conceptually explains the case in which a group distinguished by the second said group-ID can offer a component (CASE 2).

The case showed in FIG. 29 differs from this case on the point that information related to a component does not include information regarding a party of providing the component as a group including the second identifier can not also provide “MPEG4 video processor”. Therefore, in this case a group of companies having the second group identifier are common to a group of companies having the first group identifier from the point of view that neither can provide “MPEG4 video processor”, but the information regarding a group of companies (transmission information) identified by the second group identifier can neither provide a component is transmitted to a group of companies (transmission information) identified by the first group identifier. Giving the associated company or a partnership company (a company which is not a rival) information like this can keep management information regarding the future alive. Utilizing electronic mail, this transmission is made possible.

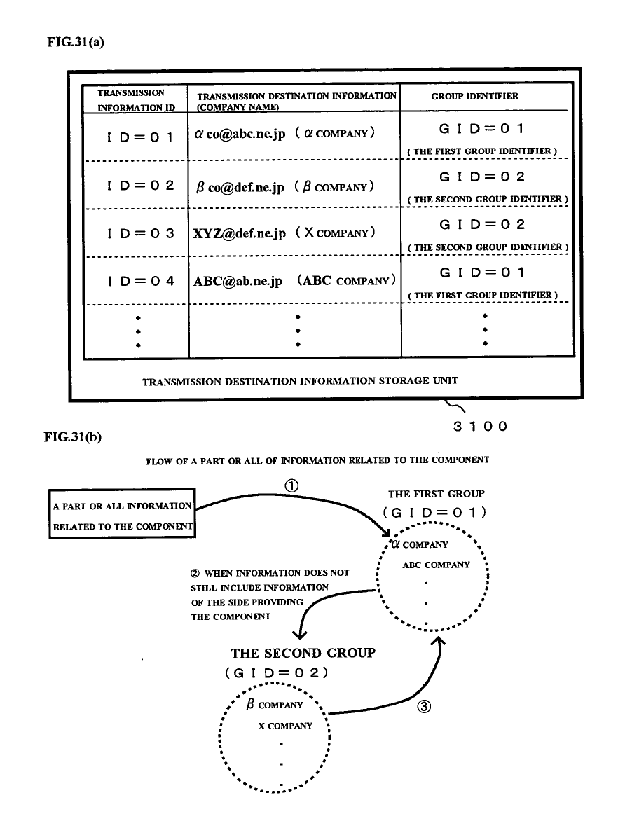

FIG. 31 conceptually illustrates a table (FIG. 31a)) to control the transmission information prepared in the transmission destination information storage unit by a group identifier, and a flow chart of component associated information which is processed by the transmission destination storage unit in this information processing apparatus.

The transmission destination information storage unit in this information processing apparatus controls transmission information by associating, as shown in FIG. 31a), transmission destination information (name of a company) with a group identifier of the transmission destination and making a form of a table. For example, a group which is “GID=01” as a group identifier is an associated company and a partnership company, and a group which is “GID=02” as a group identifier is a rival company. Then, as the process is shown in GIG.31b), at first a part or all information related to a component is transmitted to a transmission destination identified by the first group identifier, and in case that the information related to the component does not still include information regarding a party providing the component, the information related to the component is transmitted to the transmission destination identified by the second identifier. Further, the result is transmitted to transmission destination identified by the first group identifier (a company which is a group company or has a good relationship) regardless of whether or not provision of a component is possible (a replay to an information processing apparatus).

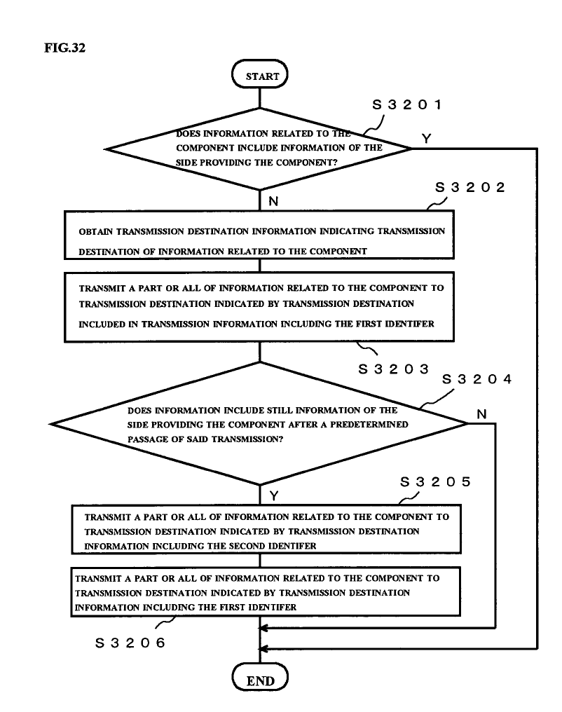

FIG. 32 shows a flow chart of a process of this embodiment. As shown in this figure, in the first step it is determined whether information related to a component includes information regarding a party providing a component (STEP S3201). If the determination results include information regarding a party providing a component, the process is finished. For example, production of a company in its own company's factory is applied because of no special need of contacting a third company for supplies. And if the determination results is not including information regarding a party providing a component, in the second step transmission destination information indicating transmission destination of information related to a component and transmission information including a group identifier of the transmission destination are retrieved (STEP S3202).

In said step the transmission information is retrieved, so that in the third step a part of all of information related to a component is transmitted to a transmission destination, which is indicated by the transmission destination information in the case that said group identifier is the first group identifier. Here, this means that “the first group identifier” differs form “the second group identifier”, and the name of the identifier is not important.

And in the fourth step, it is determined whether information related to a component does not still include information regarding a party providing a component (STEP S3204). It is necessary that the determination is made after the predetermined time passes to give a company, which is transmission destination identified by the first group identifier, time for deliberation and time for replay; except, in a case in which an automatic replay is excluded. “An automatic replay” indicates, for example, the case that there are one million components of stock, and within the limits of the stock, provision of the components is automatically performed for information related to a component, which does not include information regarding a party providing a component. Furthermore, if the determination results in the case that the information related to the component does not include information regarding a party providing a component (for example, corresponding to the case that a company of transmission destination identified by the first group identifier can not provide the applicable product.), in the fifth step, a part or all of said information related to a component is transmitted to transmission destination indicated by transmission information having the second group identifier(STEP S3205). After this information related to the component is transmitted to the a transmission destination indicated by the transmission destination information including the second identifier, this information related to the component is transmitted to transmission destination indicated by transmission destination, which includes the first identifier again. These are described above.

As briefly mentioned, the above is described as follows. That is to say, an information processing apparatus is characterized in that said group identifier includes the first identifier identifying the first group and the second identifier identifying the second group, and if said information related to the component information does not include information regarding a party providing the component, said information transmission unit transmits a part or all of said information related to the component to the first group identified by the first group identifier stored by said transmission destination information unit, if said information related to the component does not still include information regarding a party providing a component, to the second group identified by the second group identifier, and if said information related to a component does not still include information regarding a party providing a component, further to the first group.

Of course, the above is applied to the case in which there are more than three kinds of groups. In this case, information related to a component is transmitted, first of all, to a transmission destination indicated by the transmission information including the first group identifier, second, to the transmission destination indicated by the transmission information including the second group identifier, and, third, to the transmission destination indicated by the transmission information including the third group identifier. Information related to a component is transmitted to the lower groups in succession until information regarding a party providing a component is written into information related to a component such information as information destination indicated by transmission information including any group identifier can provide a predetermined component, or until any company can not provide the component.

Further, information related to a component for which information regarding a party providing a component is written into or not is, in the back order of the previous order, transmitted (fed back) to transmission destination indicated by transmission information including the first identifier. A processing of this transmission (feedback) may be preformed not only in the previous order, but also information related to a component is transmitted directly to a transmission destination indicated by the transmission destination information including the first group identifier.

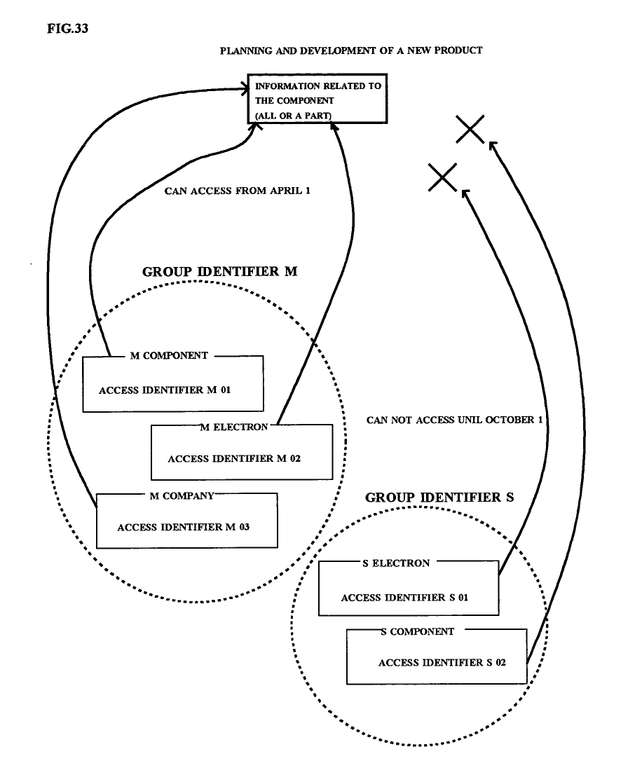

FIG. 33 shows a schematic diagram of the fifth embodiment. In this embodiment, a possible time to access information related to a component stored by the information storage unit is controlled by an access identifier (a corresponding group identifier), which identifies an access person “An access person” in this means a real person, or a terminal which is utilized for access.

As explained in the example of this figure, companies of which access identifiers are “M 01”, “M 02”, and “M 03” (M component, M electronic, M Co., Ltd) belong to a group of which an access identifier is showed by a group identifier “M” . Further, access persons (companies (M component, M electronic, M Co., Ltd)) can access information to relate to a component in an information storage unit in an information processing apparautus from April 1.

On the other hand, companies, of which access identifiers are “S 01”, “S 02”, “S 03” (S electronic, S component) belong to a group, of which an access identifier is showed by a group identifier “S”. Further, access persons (companies (S electronic, S component) can access information related to a component in an information storage unit in an information processing apparautus from October 1. That is to say, companies including a group identifier “M” can access information related to a component 6 months earlier than companies including a group identifier “S”.

Because information related to a component includes information about a device, which is an object of project and development, reading information related to a component in the information storage unit in an information processing apparatus minimizes the outflow of information regarding the project and its development. Therefore, a time condition is determined as a group of companies, which have project and development (companies controlling an information processing apparautus and the like), have earlier accessibility, and rival companies have access, so that outflow of information is controlled.

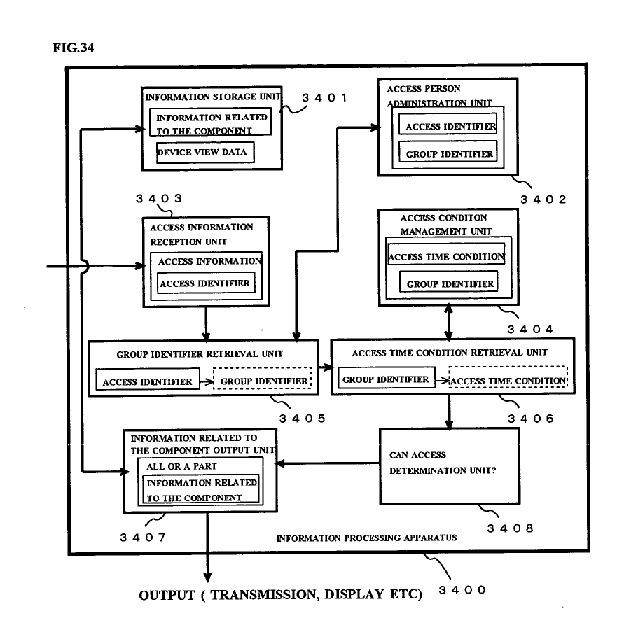

FIG. 34 shows an example of functional block diagram of an information processing apparatus of this embodiment. This information processing apparatus 3400 comprises the information storage unit 3401, the access information reception unit 3403, the group identifier retrieval unit 3405, the access person administration unit 3402, the access condition retrieval unit 3404, the access time condition retrieval unit 3406, the determination unit 3408 and the information related to a component output unit 3407. The data generation unit and data for a device component output unit are not always required. For example, there may be a data for a device component output unit in other apparatus besides this information processing apparatus 3400.

The information storage unit 3401 stores device view data and component information and/or information related to a component including information regarding a party providing the component. The access information reception unit 3403 receives access information including an access identifier. The access person administration unit administrates an access identifier identifying an access person (a person or a terminal) and a group identifier in a pair. The administration in a pair means that the access identifier is associated with the group identifier.

The group identifier retrieval unit 3405 retrieves a group identifier corresponding to an access identifier from the access person administration unit 3402 in the case that said access information reception unit 3403 receives access information.

The access condition storage unit 3404 stores an access time condition showing accessible time and a group identifier in a pair.

The access time condition retrieval unit 3406 retrieves an access time condition in a pair with a group identifier retrieved by said group identifier retrieval unit 3405. “an access time condition” may be shown as a delay from a determined time, or a delay between groups identified by a group identifier. Further, time may be shown as absolute time (for example, what year, which month, what day, what time, how many minutes).

The determination unit 3408 determines the possibility of access based on an access time condition. “Time condition” is either a combination of conditions comprising; “delay time” (delay time between an access person, who can access at a first priority, and a access person, who has an inferior condition) ; “accessible time (year, month, day, hour, minute, second and the like); and “range of accessible time” and the like. Scale of time may be any kind of scale, which is, for example, “year, month, day, minute, second” etc.

The information related to a component output unit 3407 outputs a part or all information related to a component if a determination by said determination unit 3408 results in that access is possible. In addition, “output”, as described above, includes various kinds of output configurations such as transmission, display, printout and the like. Said data generation unit and data for a device component output units are not always required.

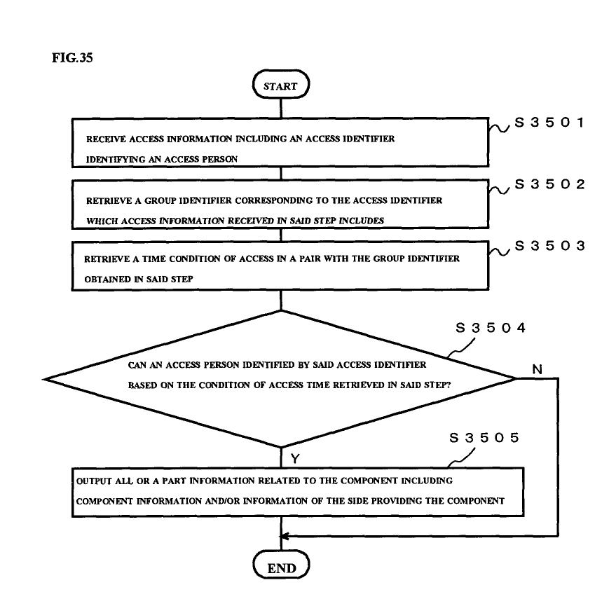

FIG. 35 shows a flow chart of a process of the fifth embodiment First of all, as shown in this figure, in the first step access information including an access identifier that identifies an access person is received (STEP S3501). Next, in the second step, a group identifier, which is corresponding to the access identifier that the access information received in said step includes, is obtained (STEP S3502). Further, in the third step an access time condition in a pair with the group identifier obtained in said step is retrieved (STEP S3503). In the fourth step, it is determined whether the access person identified by said access identifier can access based on the access time condition retrieved in said step (STEP S3404).

Finally, if the determination in said step results in access being possible, in the fifth step all or a part of information related to a component including component information and/or information regarding a party providing a component is outputted (STEP S3505).

An information processing apparatus of this sixth embodiment is based on the information apparatus of the fifth embodiment and is characterized in that range of disclosure of information related to a component for an access person differs by group identifiers.

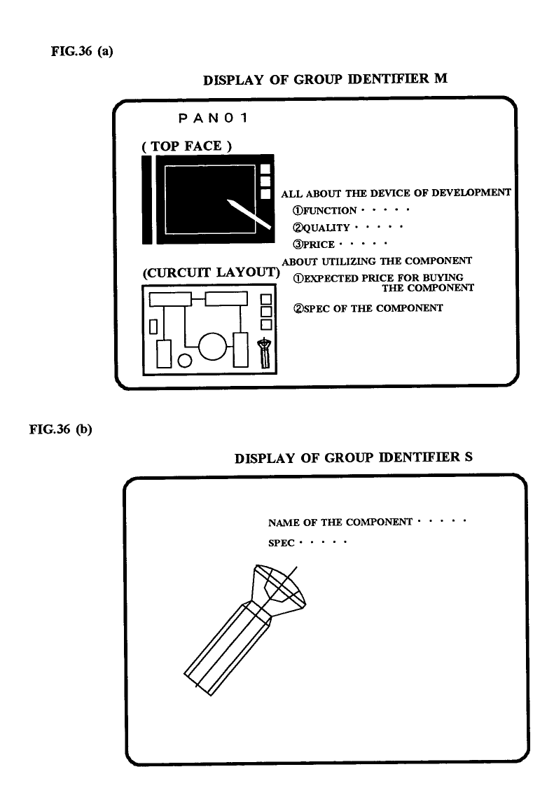

FIGS. 36(a) and 36(b) show schematic diagrams of this embodiment FIG. 36(a) shows an access person including a group identifier “M” accessing information related to a component from an information storage unit in an information processing apparatus. As described in this figure, all about a device, which are planned and developed by utilizing a component, and various kinds of information is accessible. In FIG. 36(b), a screen that is accessed by an access person including a group identifier “S” is limited to displaying only name and specifications of a component, so that information about the development and plan is not available.

In this way, for example, all information about the developments and plans is available to group companies, but restricted from rival companies. Therefore, a card of the company itself is not exposed to competition of a new product between companies.

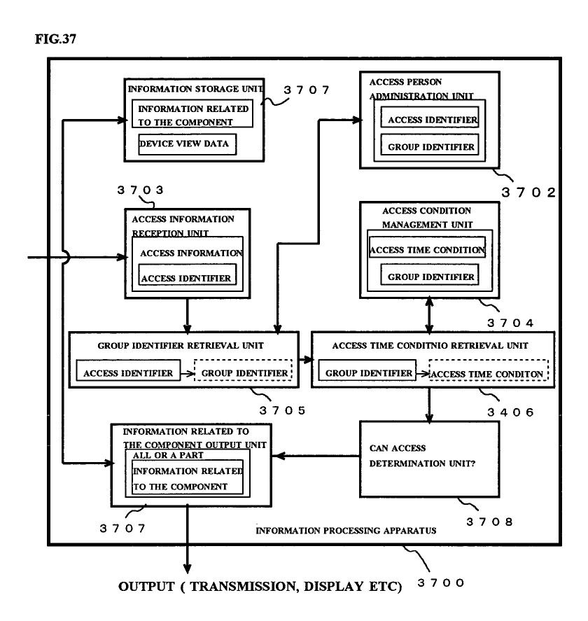

FIG. 37 shows an example of a functional block diagram of an information processing apparatus of this embodiment. As shown in this figure, functional block of this information processing apparatus 3700 is basically the same as the fifth embodiment. That is to say, the information processing apparatus 3700 comprises: the information storage unit 3701; the access information reception unit 3703; the group identifier retrieval unit 3705; the access person administration unit 3702; the access condition storage unit 3704; the access time condition retrieval unit 3706; the determination unit 3708; and the information related to a component output unit 3707. A data generation unit and a data for a device component output unit is not always required. Other apparatus besides the information processing apparatus 3700 of this embodiment may realize this embodiment.

This embodiment is characterized in that information outputted by said information related to a component output unit 3707 differs corresponding to a group identified by said group identifier. For example, the information related to a component output unit 3707 has a permission table of disclosing information related to a component, and control information related to a component that is permitted to access each group identifier following this table, so that this function is realized.

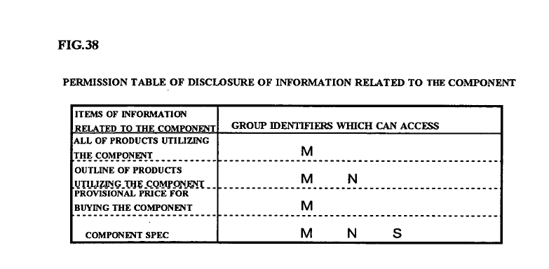

FIG. 38 shows an example of a permission table of disclosure of this information related to a component. Information related to a component corresponds with a group identifier, which is permitted to access every item. For example, A group identifier permitted to access is “M” for an item of information related to a component “all of products utilizing a component”, group identifiers permitted to access are “M” and “N” for an item of information related to a component “a summary of products utilizing a component”, and group identifiers permitted to access for an item of information related to a component “a spec of a component” are “M”, “N” and “S”.

In this embodiment, not only time condition of access but quality of accessible information can be controlled, so that an effective control of information is possible in the case of disclosure of information related to a component of a rival company.

The seventh embodiment is characterized in that the information related to a component includes information which indicates a condition in a process of inquiring a component. Information about a condition in a process of inquiring a component, which occasionally includes no only a schedule management of plan and development of a new product but also information that has a big influence on management of a company and companies which have business relation with the former, is very important information.

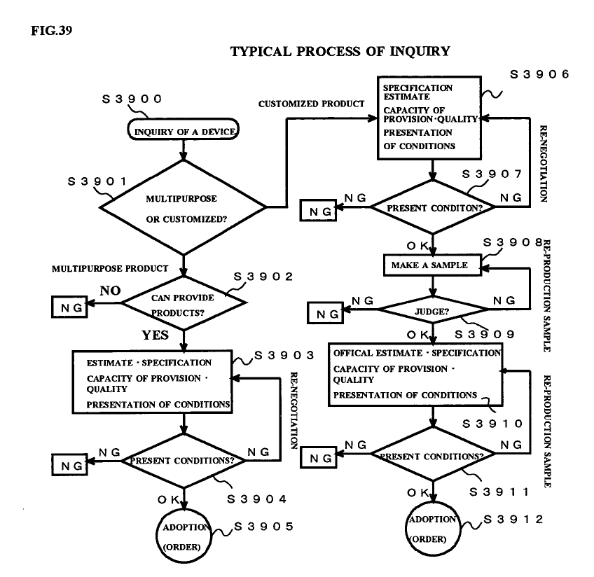

FIG. 39 shows an example of a typical inquiry process. For example, if there is an inquiry of a device (STEP S3900), first of all, it is determined whether the specification of the device is multipurpose or customized (STEP S3901). And if it is multipurpose, whether there is a product to be examined (STEP S3902), and if there is a product, conditions like an estimate, a specification and the like are shown (STEP S3903). Whether or not the shown condition is appropriate is determined (STEP S3904), and if the condition is good, it is adopted (STEP S3905). On the other hand, if the specification of the device is customized, first of all, conditions like a summary of an estimate, a summary of a specification and the like are shown (STEP S3906) , the condition is determined (STEP S3907), and if it is appropriate, a sample is made (STEP S3908). As a result of making the sample, if it is highly estimated, conditions like a formal estimate, a specification, a capacity of province and quality are shown (STEP S3912) , if it is not estimated, a sample is made again. The condition of the formal estimate is judged and if it is appropriate, it is adopted (STEP S3912). Whether the shown condition is appropriate is determined (STEP S3904), and if the condition is good, it is adopted (STEP S3905).

The conditions like the estimate, the specification, the capacity of province, quality and the like, information regarding making the sample and the result of the estimation are very important information because of including important elements of company management.

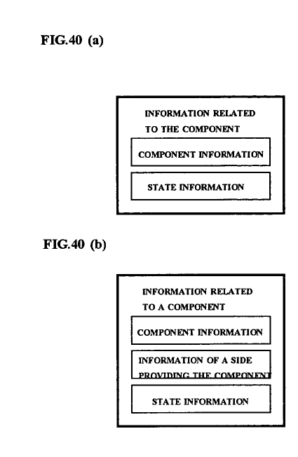

FIG. 40 shows a case that information related to a component includes state information.

FIG. 40(a) shows a case that information related to a component includes only component information and state information, and FIG. 40(b) shows a case that information related to a component includes component information, information regarding a party providing a component and state information. The case of the former is such a case of not including information regarding a party providing a component, as a provider of the component is its own company. The latter includes a component party providing a component, and associating the component party providing the component with state information becomes convenient.

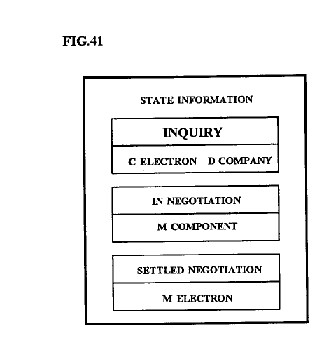

FIG. 41 shows the simplest configuration of state information. In this case, information is classified into “inquiry”, “in negotiation” and “settled negotiation”, and is connected with a sign and the like identifying information related to a component for each classification (for example, company name).

It is thought that the range of information disclosure of this state information is controlled corresponding to a group identifier.

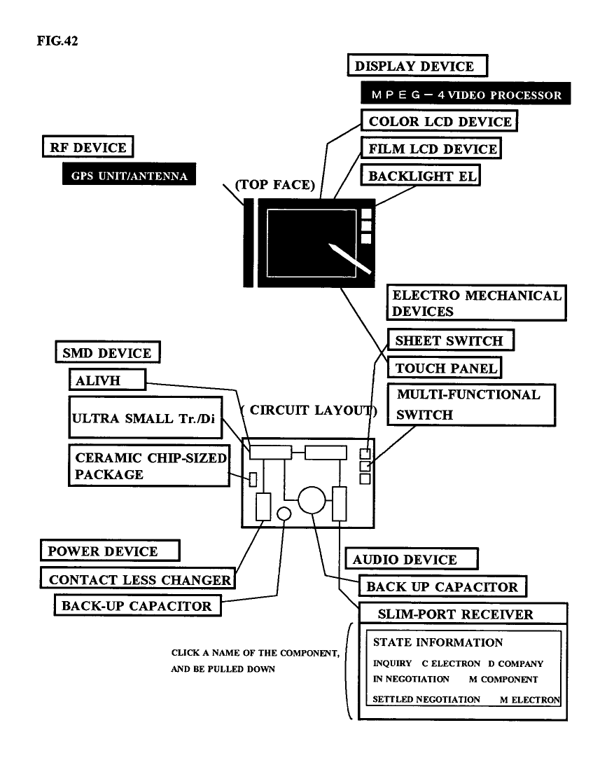

FIG. 42 shows an output example of state information. As shown in this figure, the output is thought as a name of a component on a data for a device component is clicked, and state information related to the component is pulled down. Of course, it is good to additionally display the component itself in a form like a list. It is decided whether or not information is pulled down corresponds to every identifier. In addition, this state information indicates that state of “inquiry” is “C electronic, D Co., Ltd., state of “in negotiation” is “M component”, and state of “negotiation settled” is “M electronic”. In this example, plural purchases are given to one component, but if a purchase is given to one component, negotiations become settled, and state information like “inquiry” and “in negotiation” are not displayed because negotiations with others are not needed. This embodiment is based on the eighth embodiment , wherein said information related to a component includes state information indicating a process of inquiring a component, and is characterized in that an output of information related to a component by said data for a device component output unit or all or a part of information by said information related to a component output unit differs on the different visual display corresponding to said state information.

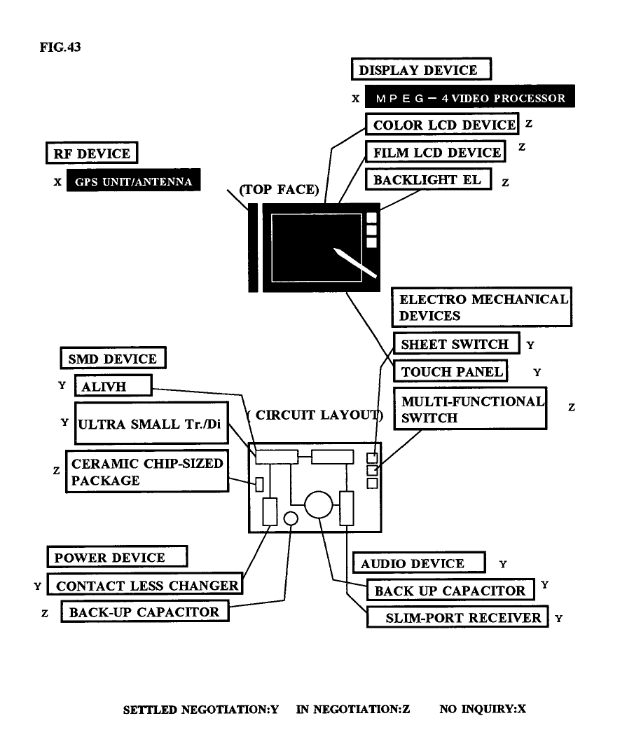

FIG. 43 shows an example of said output configuration on a visually different display. As shown in this figure, a component with settled negotiations is expressed in “Y”, a component in negotiations is expressed in “Z”, a component without an inquiry is expressed in “X”, and “Y”, “Z” and “X” are put beside a title of component of an output of data for a device component.

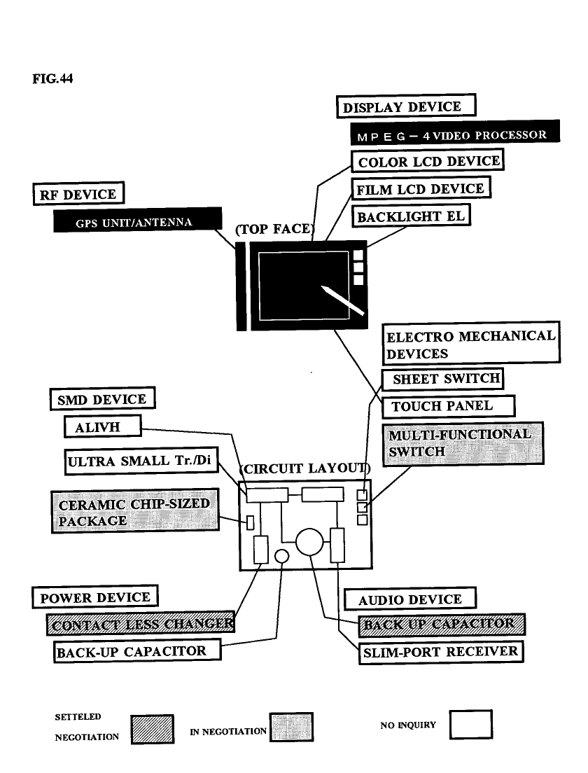

FIG. 44 shows other output configurations. In this example, a title of a component of data for a device component, wherein “settled negotiation” and “in negotiation” are in different kinds of hatch patterns, and “no inquiry”, is not in a hatch pattern.

In any event, it is possible to catch an outline of state information at first sight.

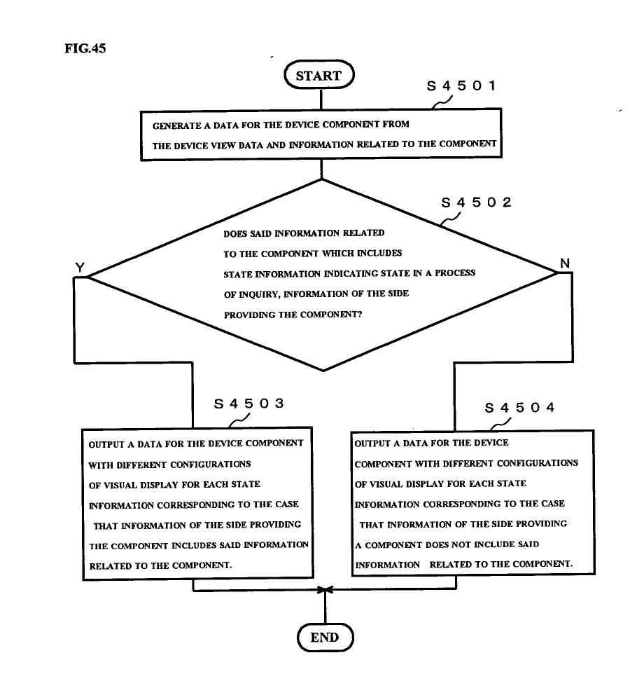

FIG. 45 shows a flow chart indicating a process of the embodiment 8. As shown in this figure, first of all a data for a device component is generated from a device view data and information related to a component (STEP S4501). Whether the information related to a component including state information, which indicates a state of a process of inquiry (for example, no inquiry, in negotiation, settled negotiation), includes information regarding a party providing a component, is determined (STEP S4502). And if said result of determination is “including”, information regarding a party providing a component corresponds to the case of including said information related to a component, and a data for a device component is outputted on a visually different display according to different state information (STEP S4503).

If said result of determination is “not including”, information regarding a party providing a component corresponds to the case of not including said information related to a component, and a data for a device component is output on a visually different display according to different state information (STEP S4504).

As explained above, this invention has been described and illustrated as comprising; a device information reception unit for receiving device information including component information, which includes component identification information identifying components that constitute a device, and a view data that constitutes a view of a device; an information storage unit for storing component provision information containing component identification information; an information retrieval unit for retrieving component provision information including component identification information that the device information received by the device information reception unit contains; and a data generation unit for generating a display data from all or a part of component provision information retrieved by the information retrieval unit, so that displaying information regarding components that constitute a product associated with a product that the device makes it effectively and reasonably possible to obtain information that clients want.

In addition, state information makes it possible to know the state of the inquiry process, so that it is easily to obtain the information, which is valid in the planning and development of a product. Furthermore, an appropriate range of disclosure of information corresponding to an access person can prevent a company itself from bringing about disadvantageous conditions by diffusion of information.

What is claimed is:

1. An information processing apparatus comprising:
a device information reception unit for receiving device information including component information that contains component identifier information, which identifies a component composing a device, and an image data displaying an image of said device;
an information storage unit for storing component provision information including said component identification information;
an information retrieval unit for retrieving the component provision information including the component identification information received by said device information reception unit from said information storage unit; and
a data generation unit for generating a display data from all or apart of said component provision information retrieved by said information retrieval unit, and said image data.

2. The information processing apparatus as claimed in claim 1,
Wherein said component information includes position information, which indicates a display position on said image data,
Wherein said data generation unit arranges at least part of said component provision information on said image data corresponding to said position information which said component information contains, and generates display data.

3. The information processing apparatus as claimed in claim 1 or claim 2, further comprising:
a display data transmission unit for transmitting the display data generated by said data generation unit.

4. The information processing apparatus as claimed in claim 1 or 2, wherein said component provision information includes patent information related to said component.

5. A terminal comprising:
a device information transmission unit for transmitting device information to the information processing apparatus as claimed in claim 3;
a data reception unit for receiving said display data that is transmitted from said information processing apparatus; and
a data display unit for displaying said display data that is received by said data receiving unit.

6. An information processing apparatus comprising:
an input reception unit for receiving a command of creating a map, a list displaying a product;
a technological data storage unit for storing technological data, which contains more than one technological record including a technology identifier to identify technology and a product identifier to indicate annum and the product utilizing said technology;
a data read unit for reading the technological record from said technological data storage unit, according to the command of composition received by said input reception unit;
a layout determination unit to determine a display position for said technological identifier on the map, which has plural concentric circles that annum is modernized from the core to a circumferential direction and that said plural concentric circles are divided into fan-shaped portions;
a map creation unit for arranging said technology identifier on said display position calculated by said layout calculation unit, and creating said map; and
a map output unit for outputting said map created by said map creation unit.

7. An method of displaying information comprising:
a device information retrieval step of retrieving device information including component information, which composes a device, and a view data, which is an image of said device;
a component information retrieval step of retrieving component provision information, which includes component mark information that is contained in said component information retrieved in said device information retrieval step;
a data generation step of generating display data from said component information provision and the view data retrieved in said component information retrieval step; and
a data display step of displaying said display data generated in said data generation step.

8. The method of displaying component information as claimed in claim 7,
wherein said component information include position information, which indicates a display position on said view data, and
wherein said data generation step, further comprising the steps of:
arranging at least a portion of said provided component information on said view data corresponding to said position information which said component information contain; and
generating display data.

9. The method of displaying information as claimed in claim 7 or 8, further wherein said component provision information has patent information related to said component.

10. A method for displaying information, comprising:
a data read step of reading technological data which contains a plurality of technology records including a technological identifier to identify technology and a product identifier to indicate annum and a product utilizing said technology;
a layout determination step of determining a display position of said technical identifier on the map which has plural concentric circles that annum is modernized from the core to a circumferential direction and that said plural concentric circles are divided into fan-shaped portions, corresponding to said annum and said product identifier that is contained in the technology record read in said data read step;
a map creation step of arranging said technological identifier on said display position calculated in said layout determination step, and creating said map; and
a map output step of outputting said map created in map creation step.

11. An information processing apparatus comprising:
an information storage unit for storing a device view data and information related to a component which includes component information and/or information regarding a party providing a component;
a data generation unit for generating data for a device component from the device view data and the information related to the component stored by said information storage unit; and
a data for a device component output unit for outputting the data for the device component generated by said data generation unit, and
wherein information related to the component is outputted by said data for the device component output unit, on a different display corresponding to whether said information related to the component includes information regarding the party providing the component.

12. An information processing apparatus comprising:
an information storage unit for storing a device view data and information related to a component, which contain component information or information regarding a party providing a component;
a data generation unit for generating a data for the device component from the device view data and the information related to the component stored by said information control unit;
a data for a device component output unit for outputting the data for the device component generated by said data generation unit;
a destination information storage unit for storing more than one destination information which indicates a destination of information:
a destination information obtaining unit for obtaining the destination information stored by said destination information storage unit; and
an information transmission unit for transmitting a part or all of said information related to the component to the destination which the destination information obtained by the destination information obtaining unit indicates, in the case that said information related to the component does not have information regarding the party providing the component.

13. The information processing apparatus as claimed in claim 12,
wherein said destination information storage unit stores more than one group identifier to identify a group of a destination and one transmission information containing the destination information, and
wherein, in the case that said information related to the component does not contain the information regarding the party providing the component, the timing to transmit a part of or all said information related to the component is different for every group identified by the group identifier stored by said destination information storage unit.

14. The information processing apparatus as claimed in claim 13,
wherein said group identifier includes the first group identifier to identify the first group and the second group identifier to identify the second group, and
wherein, in the case that said information related to the component does not contain information regarding the party providing the component, said information transmission unit transmits a part or all said information related to the component to the first group identified by the first group identifier, if said information related to the component still does not have the information regarding the party providing the component, to the second group identified by the second group identifier, and if said information related to the component does not contain information regarding the party providing the component, further to the first group.

15. An information processing apparatus comprising:
an information storage unit for storing device view data and information related to a component, which contain component information or information regarding the party providing the component;
an access person administration unit for administration of an access identifier to identify an access person and a group identifier in a pair;
an access condition storage unit for storing an access time condition information indicating accessible time, and a group identifier in a pair;
an access information reception unit for receiving access information containing an access identifier;
a group identifier retrieval unit for retrieving a group identifier from said access person administration unit corresponding to the access identifier which said access information contains, in the case that access information is received by said access information reception unit;
an access time condition retrieval unit for retrieving the access time condition, matched with the group identifier retrieved by said group identifier retrieval unit;
a determination unit for determining whether it is accessible corresponding to the access time condition retrieved by said access time condition obtaining unit; and
an information related to a component output unit for outputting all or a part of information related to a component, in the case that determination by said determination unit is to be accessible.

16. The information processing apparatus as claimed in claim 15, wherein the information output by said information related to the component output unit is different corresponding to the group identified by said group identifier.

17. A computer program for performing the following steps comprising:
a step of generating a data for a device component from device view data and information related to a component;
a step of determining whether said information related to the component includes information regarding the party providing the component;
a step of outputting the data for the device component, on the visual output display corresponding to the case that said information related to the component includes information regarding the party providing the component; and
a step of outputting the data for the device component, on the visual output display corresponding to the case that said information related to the component does not include information regarding the party providing the component.

18. A computer program for performing the following steps comprising:
a step of determining whether information related to a component includes information regarding a party providing a component;
a step of obtaining destination information which indicates a destination of the information related to the component in the case that the information related to the component does not include information regarding the party providing the component; and
a step of transmitting a part or all of the information related to the component to the destination which the destination information obtained in said step indicates.

19. A computer program for performing the following steps comprising:
a step of determining whether information related to a component includes information regarding a party providing a component;
a step of obtaining destination information, which indicates a destination of the information related to the component, and transmission information including a group identifier in the case that the information related to the component does not include information regarding the party providing the component;
a step of retrieving the group identifier included in said transmission information; and
a step of transmitting a part of or all information related to the component to the destination which the transmission information obtained in said step indicates, at different timing every group identified by the group identifier retrieved in said step.

20. A computer program for performing the following steps comprising:
a step of determining whether information related to a component includes information regarding a party offering a component;
a step of obtaining destination information, which indicates the destination of the information related to the component, and transmission information containing a group identifier, which includes the first group identifier and the second group identifier in the case that the information related to the component does not include information regarding the party providing the component;
a step of transmitting at least a portion of said information related to the component to the destination indicated in the destination information which is contained in the transmission information including the group identifier;
a step of determining, after the appointed time passage of said transmission, whether the information related to the component still includes information regarding the party of providing the component;
a step of transmitting a part or all of the information related to the component to the destination which the destination information including the second group identifier indicates if the information related to the component still does not include information regarding the party of providing the component after the appointed time passage of said transmission; and
a step of transmitting a part or all of the information related to the component to the destination which the destination information including said first group identifier indicates, after the appointed passage of performing the step of transmitting the information related to the component to the destination indicated by the destination information including said second group identifier.

21. A computer program for performing the following steps comprising:
a step of receiving access information including an access identifier to identify an access person;
a step of retrieving a group identifier corresponding to the access identifier that is contained in said access information received in said step;
a step of retrieving the access time condition that matches with the group identifier retrieved in said step;
a step of determining, based on the access time condition retrieved in said step, whether the access person identified by the access identifier is accessible; and
a step of outputting all or a part of the information related to the component containing component information or information regarding the party of providing the component in the case that the access person is accessible.

22. The program as claimed in claim 21, wherein different kinds of information are output, every group identified by said group identifier in the step of outputting all or a part of said information related to a component.

23. A method for information processing, comprising the steps of:
generating a data for a device component from a device view data and information related to a component;
determining whether said information related to the component includes information regarding the party providing the component;
outputting the data for the device component on the visual output display corresponding to the case that said information related to the component includes information regarding the party providing the component; and
outputting the data for the device component, on the visual output display corresponding to the case that said information related to the component does not include information regarding the party providing a component.

24. A method for processing information, comprising the steps of:
determining whether information related to a component includes information regarding a side providing a component;
in the case that the information related to the component does not include information regarding the party providing the component, obtaining destination information which indicates the destination of the information related to the component; and
transmitting at least a portion of the information related to the components to the destination which the destination information obtained in said step indicates.

25. A method for information processing comprising the steps of;
determining whether the information related to the component includes information regarding the party providing the component;
in the case that the information related to the component does not include information regarding the party providing the component, obtaining destination information which indicates the destination of the information related to the component, and transmission information containing a group identifier;
retrieving the group identifier contained in said transmission information; and
transmitting at least a portion of the information related to the component to the destination which the transmission information obtained in said step indicates, at different timing corresponding to every group identified by the group identifier retrieved in said step.

26. A method for information processing, comprising the steps of:
determining whether information related to a component includes information regarding a party providing a component;
in the case that the information related to the component does not include information regarding the party providing the component, obtaining destination information which indicates the destination of information related to the component, and transmission information including a group identifier, which contains the first group identifier and the second group identifier;
transmitting at least a portion of said information related to the component to the destination indicated by the destination information which is contained in the transmission information including the first group identifier;
determining, after the appointed passage of time from said transmission, whether information related to the component does not include information regarding the party providing the component;
in the case that the information related to the component does not include information regarding the party providing the component, transmitting a part or all of said information related to the component to the destination which the destination information including said second group identifier indicates; and
transmitting, after the appointed time passage from said transmission, a part or all of the information related to the component to the destination which the destination information including the first identifier indicates.

27. The information processing apparatus as in any one of claims 11-16, wherein said information related the component includes condition information which indicates a condition in a process of inquiry to the component.

28. The information processing apparatus as claimed in claim 27, wherein the information related to the component output by said data for the device component output unit is different on visual display from at least a portion of the information to related to the component by said information related to the component output unit corresponding to the case that said condition information differs.

29. The information processing apparatus as in any one of claims 17-22, wherein said information related to the component includes condition information, which indicates a condition in a process of inquiry to the component.

30. A computer program for performing the following steps, comprising the steps of:
generating a data for a device component from information related to a component, which includes, in some cases, device view data and information regarding the party of providing the component;
determining whether said information related to the component, which indicates a condition in a process of inquiry to component, includes information regarding the party providing the component;
outputting the data for the device component, on the visually different output display corresponding to the case that said information related to the component includes information regarding the party providing the component; and
outputting a data for a device component on the visually different output display corresponding to the case that said information related to a component does not include information regarding a party providing a component.
